(19) United States
(12) Patent Application Publication
(10) Pub. No.: US 2026/0021587 A1
(43) Pub. Date: Jan. 22, 2026

(54) UNDERSTANDING ROBOTIC TOUCH PARAMETERS THROUGH PARTICIPATORY EXPERIMENTS OF PHYSICAL HUMAN-ROBOT INTERACTIONS

(71) Applicant: Honda Motor Co., Ltd., Tokyo (JP)

(72) Inventors: Yuhan HU, Santa Clara, CA (US); Xiyu FU, Itaca, NY (US); Rana SOLTANI ZARRIN, Los Gatos, CA (US)

(73) Assignee: Honda Motor Co., Ltd., Tokyo (JP)

(21) Appl. No.: 19/002,183

(22) Filed: Dec. 26, 2024

Related U.S. Application Data
(60) Provisional application No. 63/673,116, filed on Jul. 18, 2024.

(51) Int. Cl. B25J 9/16; B25J 15/10; G06N 3/006

(52) U.S. Cl. CPC B25J 9/1694; B25J 15/10; G06N 3/006

(57) ABSTRACT

A method for determining robotic touch parameters through participatory experiments of physical human-robot interactions is provided. The method may select different robotic parameters for performing different robotic touch tasks by a participant. The method may experience each robotic touch task with the different robotic parameters selected by the participant for a first time. The method may evaluate each robotic touch task with the different robotic parameters selected by the participant. The method may update the different robotic parameters for performing the different robotic touch tasks by the participant.

### RELATED APPLICATIONS

This patent application is related to U.S. Provisional Application No. 63/673,116 filed Jul. 18, 2024, entitled “UNDERSTANDING ROBOTIC TOUCH PARAMETERS THROUGH PARTICIPATORY EXPERIMENTS OF PHYSICAL HUMAN-ROBOT INTERACTIONS”, in the names of the same inventors and which is incorporated herein by reference in its entirety. The present patent application claims the benefit under 35 U.S.C § 119(e) of the aforementioned provisional application.

### BACKGROUND

As robots increasingly engage in real-world tasks that may involve direct interaction with humans, there may be a need for the development of human-friendly robots. These robots should embody a notion of freedom, which may encompass being feasible, time-efficient, and intuitive in their behaviors, and should ensure consistent comfort level for human usage. Assistive robots should be physically as well as psychologically comfortable while considering the efficacy of the human-robot team.

Research in physical human-robot touch interactions may delve into emotional and psychological comfort levels, targeting social and affective touch aspects. These studies may propose diverse metrics for assessing human perception of touch, and may encompass objective measures like physiological stress, facial expressions, body movements, and subjective evaluations such as comfort, trust, bonding, emotions, and the like.

According to recent studies, users' experience may differ when the users are touched in different regions of the body. For example, being touched on the arm may elicit a different emotional response than being touched on the head. In human-human touch research, touching the head and upper torso may be more acceptable by closer acquaintances whereas strangers may be allowed to touch one's arm. Currently, there is limited literature comparing the experiences of robotic touch on various body regions. Most studies have focused on human experiences when touched on the arms, though some may have examined contexts such as robotic hugs or interactions involving a robot patting the head or rubbing the back. Recognizing the importance of body parts in shaping user experience of touch and for better understanding direct general robotic touch, in this way one may consider two distinct contexts: touching arm and touching the head, to better understand the range of human responses to robotic touch.

Previous research in human-robot interaction (pHRI) may have demonstrated that human acceptance and trust of robotic touch may depend on how comfortable the interaction felt. With designed artifacts and infrastructure aiming to ensure and monitor comfort, user studies may have developed a systematic mapping of the dimensions of comfort. In the literature in human-human touch interactions, researchers may emphasize comfort level and intuitiveness as major determinant of touch quality. Touch experienced may be positive when it was appropriate to the situation, did not impose greater intimacy than desired, and did not impart a condescending message.

While observations may have been made in understanding such parameters individually, there may remain a need for a comprehensive approach that reviews and integrates all these factors to fully understand user experiences in the context of physical human-robot touch.

Thus, one may aim to capture a range of response and understand how these parameters may be correlated. Leveraging insights from both pHRI and human-human interaction (pHHI) literature, one may develop research questions focused on understanding how humans may perceive comfort levels and intuitiveness when being touched by robots, while remaining open to additional metrics that may emerge from the below thematic analysis.

HRI may recognize the importance of qualitative and design research in exploratory studies, and the importance of capturing nuances. Some of these may include physical embodiment co-design and others may have looked into behavior generation and design with children, highlighting the value of participatory methods.

On the pHRI side however, existing research has primarily focused on interview-based approaches, with limited exposure to physical hardware and embodied interaction experiences throughout the design iterations. Ranging from robotics prototype testing to longitudinal studies in social work, participants may be involved only in the evaluation phase, without playing an active role in the iterative design and improvement of robotic behaviors.

To fill the gap and advance the field's understanding of human perceptions of generalized robotic touch, one may use the participatory co-design approach to actively involve participants into both the design and evaluation phases of the robotic touch behaviors, which may include pre-design bodystorming, in-study robot parameter specification, iteration, and post-design touch execution, evaluation, and interviews. By integrating participatory design with direct physical interaction, one may address the mentioned limitations in pHRI studies, which may ensure that results may be both comprehensive and relevant to a broad spectrum of practical applications.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for determining robotic touch parameters through participatory experiments of physical human-robot interactions is provided. The method may select different robotic parameters for performing different robotic touch tasks by a participant. The method may experience each robotic touch task with the different robotic parameters selected by the participant. The method may evaluate each robotic touch task with the different robotic parameters selected by the participant. The method may update the different robotic parameters for performing the different robotic touch tasks by the participant.

According to another embodiment of the disclosure, a method for determining robotic touch parameters through participatory experiments of physical human-robot interactions is provided. The method may perform a bodystorming activity allowing each participant of a plurality of participants to perform a human touch action on a mannequin. The method may determine individually different robotic parameters for performing different robotic touch tasks by each participant. The method may experience by each participant each robotic touch task with the different robotic parameters corresponding with each participant. The method may evaluate by each participant the experience of each robotic touch task with the different robotic parameters corresponding with each participant. The method may update by each participant the different robotic parameters for performing the different robotic touch tasks. The method may experience by each participant each robotic touch task with the updated different robotic parameters corresponding with each participant. The method may evaluate by each participant the experience of each robotic touch task with the updated different robotic parameters corresponding with each participant.

According to another embodiment of the disclosure, a method for determining robotic touch parameters through participatory experiments of physical human-robot interactions is provided. The method may perform a robotic force demonstration showing a plurality of different applied robot force levels to an object. The method may perform a practice task with each participant allowing each participant to experience at least one of the different robotic parameters. The method may perform a bodystorming activity allowing each participant to perform a human touch action on a mannequin. The method may allow each participant to individually select different robotic parameters for performing different robotic touch tasks. The method may allow each participant to experience each robotic touch task with the selected different robotic parameters corresponding with each participant. The method may evaluate the experience of each robotic touch task with the selected different robotic parameters corresponding with each participant. The method may adjust the different robotic parameters for performing the different robotic touch tasks by each of the participants. The method may allow each participant to experience each robotic touch task with the adjusted different robotic parameters corresponding with each participant. The method may evaluate the experience of each robotic touch task with the adjusted different robotic parameters corresponding with each participant.

### BRIEF DESCRIPTION OF THE DRAWINGS

FIGS. 1A-1C depict exemplary physical interaction tasks for exploring and designing robot behavior in accordance with an embodiment of the disclosure;

FIGS. 2A-2D depict exemplary experimental interactions for exploring and designing robot behavior in accordance with an embodiment of the disclosure;

FIG. 3 depicts an exemplary robotic setup with parameter specifications in accordance with an embodiment of the disclosure;

FIG. 4 depicts an exemplary robotic setup with parameter specifications in accordance with an embodiment of the disclosure;

FIG. 5 depicts an exemplary experimental setup for exploring and designing robot behavior in accordance with an embodiment of the disclosure;

FIGS. 6A-6C show exemplary charts depicting quantitative results of robot parameters specified by users for exploring and designing robot behavior in accordance with an embodiment of the disclosure;

FIGS. 7A-7C show exemplary charts depicting speed specifications during trajectory stages for different users for exploring and designing robot behavior in accordance with an embodiment of the disclosure;

FIGS. 8A-8B show charts depicting quantitative results of user perceptions of comfort for exploring and designing robot behavior in accordance with an embodiment of the disclosure;

FIG. 9 show charts depicting hand pose data specified by the users for exploring and designing robot behavior in accordance with an embodiment of the disclosure;

FIG. 10 shows a process diagram depicting qualitative and quantitative analysis for exploring and designing robot behavior in accordance with an embodiment of the disclosure;

FIG. 11 shows a summary of a final codebook with codes, categories, and example quotations under each category for exploring and designing robot behavior in accordance with an embodiment of the disclosure; and

FIG. 12 shows a diagram depicting robot design recommendations in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

Realizing robotic touch that achieves acceptance and trust of human users may require an understanding of robotic touch parameters and their effect on user perception of comfort. The below work may explore such parameters through a participatory experiment and may generate design principles for robotic touch, involving multiple participants in designing, evaluating, and iterating robotic parameters for instrumental touch tasks using a robotic arm equipped with a robotic hand. One may find that parameters such as robot's speed, force, and motion, contact surface material, and the robot hand pose may impact users' perception of comfort, intuitiveness, efficiency, effectiveness, trust, and sense of agency. One may find that the choice of the robotic parameters may be task-dependent, body part dependent, and intercorrelate with each other. Through the findings of below, one may provide some design guidelines for generating user-friendly robotic touch interactions.

Robots capable of physically interacting with humans may expand the human capabilities. Such interactions and the associated benefits may be relevant to both domestic and industrial applications. To achieve the widespread acceptance and trust in these technologies, it may be important to understand how humans perceive the robotic touch behaviors and what parameters may contribute to such perception. Thus, one may aim to understand how robotic touch parameters may affect user perception of comfort and may generate design principles for human-friendly generalized robotic instrumental touch.

Previous research in pHRI may have demonstrated that human acceptance of robotic touch may depend on how comfortable the interaction felt. In the context of human-human touch interactions, the quality of touch may depend on comfort and intuitiveness. While both fields may have made observations in understanding these parameters individually, there may be a need for a comprehensive approach that reviews and integrates all these factors to fully understand user experiences in the context of physical human-robot touch. Existing pHRI research has primarily relied on interview-based methods, with limited exposure to physical hardware and embodied interaction experiences throughout the design iterations. Additionally, participants may be involved only in the evaluation phase of the generated robotic behavior and do not actively participate in their design and improvement. The present disclosure may aim to fill this gap by investigating the interplay between human perceptions and robotic parameters through participatory experiments of the physical interactions, providing a holistic view of what may make robotic touch interactions comfortable, and intuitive.

One may use an exploratory participatory design approach, which may allow participants to design, evaluate, and iterate robotic parameters for performing different touch tasks, which may include wiping the arm and grooming the hair. One may conduct a series of co-design experiments and interviews with multiple participants. One may collect participants' specifications of robotic speed, force, trajectory waypoints, material, and hand pose as the main design parameters for their preferred robotic behaviors in performing predefined tasks. After each design, participants may evaluate the experience by having the robot perform the touch on their bodies and self-report their perceived comfort levels. Participants may improve their design by tuning the parameters they specified after the first iteration and sharing insights on what parameters they would like to change and why. Participants may implement the changes, perform a second iteration, and conclude on the preferable parameters for the task. One may register both participants' qualitative and quantitative feedback during the discussion and evaluation each time they execute the robot touch, as well as the robot parameters they specified in each iteration for further analysis.

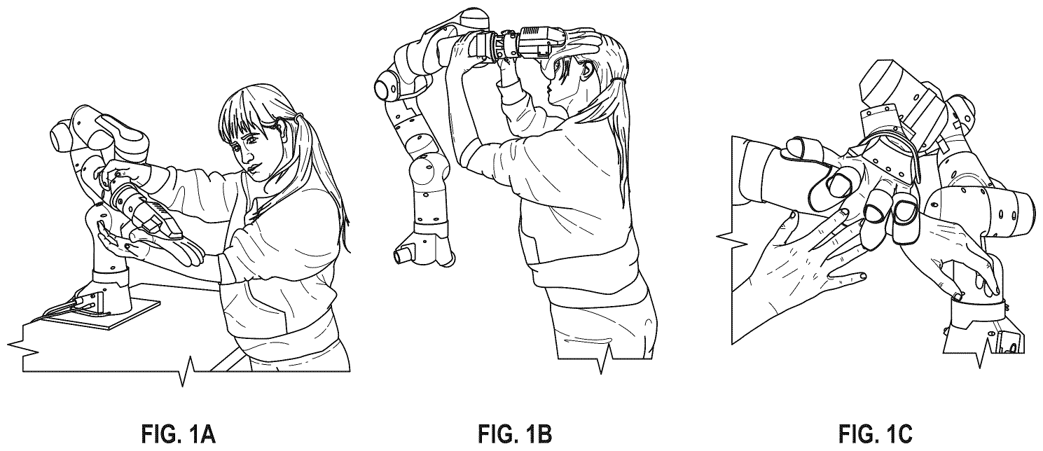

Through quantitative analysis and qualitative thematic analysis, one may find that robot parameters such as contact surface material, robot hand pose during touch, force, trajectory, speed, and proximity that may affect various human perception metrics, which may include perceived comfort, intuitiveness, efficiency, task effectiveness, trust, and sense of agency. One may find that participants may have different perceptions and tolerances for the two tasks of wiping the arm as may be shown in FIG. 1A and grooming the hair as may be shown in FIG. 1B—the head may be perceived as a more sensitive and less comfortable part to be touched by the robot, accepting a lower force than that used on an arm. The speed parameter may correlate with the trajectory phases and proximity to the participants, such that as the robot gets closer to the user, a lower speed may be preferred. Additionally, the speed of the approaching phase may be more important than the speed of the leaving phase during the trajectory. Materials may affect comfort levels as may be shown in FIG. 1C, with participants generally preferring soft and smooth materials like organic fabric. Regarding hand poses, participants may tend to adjust the curvature of the hand pose more frequently than the tilt in participants' specifications, with different tasks and body parts requiring different hand poses. Furthermore, one may find that different robotic parameters may correlate with and compensate for each other in how they may affect the user perception, for example, a softer material may give more tolerance of the trajectory specification and may affect the perceived force being applied on the user.

Through qualitative analysis, one may provide design guidelines for future robots to implement in performing comfortable, and intuitive physical touch interactions, which may include design considerations for force, speed, trajectory waypoints, time delay, hand material, hand pose, and finally, the verbal and nonverbal communications from the robot.

Through an exploratory approach, the present disclosure may offer a thorough analysis of how specific robotic parameters may affect human perceptions and experiences of physical human robot touch. By leveraging the quantifiable robot parameter data and qualitative participatory responses, the below method may ensure the insights may be grounded in real user experiences and preferences. Through this disclosure, one may provide useful insights and design guidelines for physical human-robot interaction, encouraging more studies using participatory methodologies to explore human perceptions through physical and exploratory user research.

The present disclosure may aim to understand two research questions:
Q1: How do humans perceive comfort and intuitiveness when being touched by robots?
Q2: What are the design principles for robots when initiating instrumental touches in human-robot interactions?

Due to the nature and broadness of the questions, instead of taking a hypothesis driven approach, one may use the exploratory design method while being informed by an initial hypothesis of the correlations between the robotic parameters and the human perception, which may be inspired by literature of physical human-human interaction as well as human-robot interactions.

One may use the participatory design methodology, and let the users participate in the design and specification of the robot behaviors as well as the evaluation of the experience of the touch. To allow the participants to experience different touch behaviors and improve them, one may have two iterations for each task and ask the participant to improve the robot behaviors as well as discuss the participants' insights for different robot parameters and their effects on touch experiences for the two design iterations, reflected during their design and interaction process. With this approach, one may hope to let the participants generate user-preferred robot specifications on their own and evaluate and evolve the specifications through design iterations. One may ask the participants to focus on the aspect of comfort and intuitiveness during the participants' specifications and evaluations. One may gather participants' design insights and evaluation feedback to inform the design principles for robotic touch behaviors.

To simulate the real-world robotic instrumental touch operations, one may design two tasks for participants to specify the robot behaviors and experience the robotic touch: wipe the arm and groom the hair. The considerations behind choosing these tasks may be that: (1) the two tasks cover different body parts—head and arm—with different levels of sensitivity. One may like to compare between the two tasks especially regarding the perceptions on different contact zone of the human body; (2) the two tasks may be common operations in the scenarios such as health care and elderly home care, that may be potentially replicated with robots; (3) the two tasks may require direct touch with the human body, and may be relatively low-risk high-tolerance tasks. One may use a within-subject design, for each participant to design and experience the two tasks and discuss the participants' experiences. To counterbalance the order effect, one may randomize the order of the two tasks.

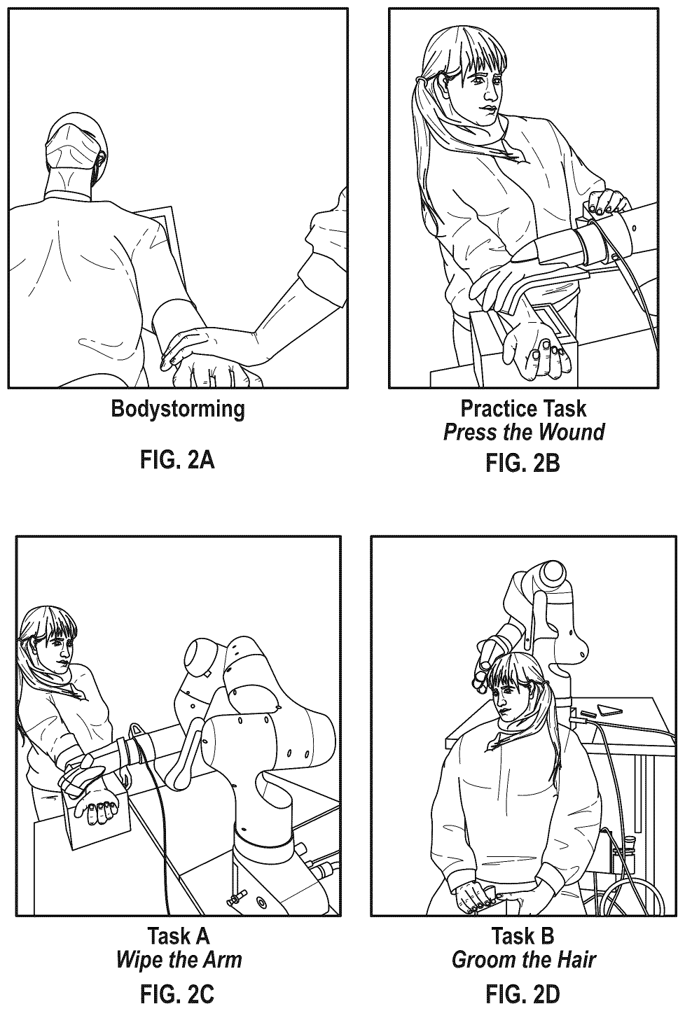

One may add a practice task, such as press the wound, to get participants familiarized with the robot parameters and the design process, as well as to allow participants to experience how different parameters, especially the force, may feel in the touch operation. Referring to FIG. 2B, one may choose to press the wound as the practice task because it may allow the experience of different forces and may be a task that may require relatively simple motion. The practice task may be performed only once, since the goal may be to help the participant familiarize themselves with all the robot control parameters that the participants may design and specify.

Referring to FIG. 2A, before the start of the robotic specifications, one may create a bodystorming activity to allow participants to generate the behaviors with natural human touch actions on a mannequin. Bodystorming is a design thinking technique that may involve role-playing and simulation in a physical environment to generate ideas and empathize with the participants. It may provide a first-person, embodied experiences in the situated context. By facilitating a deeper, more empathetic connection between participants and the robotic interface, bodystorming may help mitigate potential biases and may build trust, encouraging participants to share the participants' true thoughts and feelings, which may lead to more representative and applicable findings. In the present design, one may ask the participants to act out as a robotic arm, how they would like to interact with the human to complete the tasks in the bodystorming, and let the participants translate the behaviors to the robotic platform in participants later specifications.

FIG. 2C may illustrate when a participant is performing a wipe the arm task, while FIG. 2D may show a participant performing a groom the hair task. The bodystorming may serve two purposes in the experiment: (1) help the participants think aloud by acting out the actions with their bodies, thus making it easier to verbalize and implement later with robotic behaviors; (2) collect recordings of participants' behaviors when performing “human-human touch interactions”, and this data can be analyzed further when needed to train robotic models for mimicking such behaviors.

### Hardware Set-up

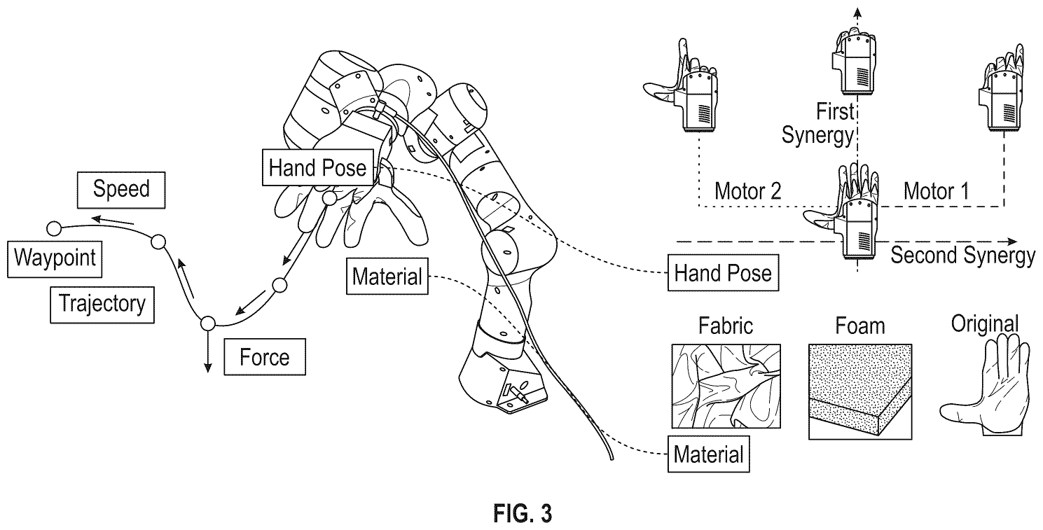

Robotic Implementation. As may be shown in FIG. 3, one may use a commercialized robotic arm and hand as the experimental hardware. One may use the simplistic arm-hand integration instead of a humanoid robot as one may like to minimize the effects of the form and other modalities and focus on the touch-related parameters. The platform may employ a 7-DOF Franka Emika Robot Arm (FR3) and a 2-DOF cable-driven robotic hand (qb SoftHand2) to execute robotic touch. A PC may be used to connect and control the movements of the arm and hand. For the Franka Arm, behaviors may be executed with a Cartesian-Impedance-Controller, specifying trajectory waypoints (cartesian pose), speed, maximum force, and duration. The Franka Arm may be controlled with the Desk interface, specifying parameters such as impedance, force threshold, speed, and joint positions. It may be controlled through Franka Control Interface (FCI), which may consist of several open-source components including ROS and C++ implementations. In accordance with one setup, one may use the Desk interface to specify and control the robotic parameters.

Robot Parameters. One may incorporate the tutorials and robotic interfaces to enable the participants to design different robot behaviors by specifying the parameters.

Material. One may provide different materials as may be shown in FIG. 3. For example, one may provide two attachable materials to the participants, including a 5 mm soft sponge layer, and a 1 mm cloth fabric layer, thus forming three options to choose from for the hand material—original hand, fabric, and sponge. The three materials may feature different softness, smoothness, and textures to help understand what the general considerations and preferences are when selecting materials for touch-related tasks.

Hand Pose: Referring to FIG. 3, hand pose may be controlled through two synergies realized by two motors. Participants may control the hand pose to its desired configuration using the sliders of the qb SoftHand2 Research GUI which may set command values for the two motors. The first degree-of-freedom may control opening and closing of all the 5 fingers simultaneously—it may be a continuous value chosen between 0 and 5000, where 0 is when the hand is completely open (flat) and 5000 is when the hand is completely closed (fist). It may be used to adjust how open or close the hand is and its level of encasing. The second degree-of-freedom may range between −10000 to +10000, where 0 may be the neutral pose of the hand; moving to the positive values may bring the thumb and index fingers together enabling a pinching motion. One may denote the first synergy as synergy 1 and the second synergy as synergy 2.

Trajectory Waypoint: Trajectory may be specified by first pressing the guiding button on the side of the robot arm to enable moving the robot freely in space. The participants may move the robot to the waypoint the participants would like the robot to reach, release the button, and notify the researcher to save the waypoint. The robot may automatically generate a path between the saved waypoints in the order of the participants' specifications and may visit all the specified waypoints starting from the first point and stopping at the last specified point. Participants may specify as many waypoints as they wish to complete the task. For example, in FIG. 3, five waypoints may be specified in the illustrated trajectory.

Speed: Between every two connecting waypoints, speed may be separately specified. For example, in FIG. 3, four speed parameters may be specified in the trajectory. The allowable speed values between minimum and maximum values may be parameterized through a linear scale to correspond to discrete levels of 1 to 10, where 10 is the maximum speed, one may set for the experiment which is 100 mm/s for the movement of the end effector in Cartesian space. The default speed may be set at 5 for all the waypoints and participants may choose to speed it up or slow it down by specifying a number in the annotated sketch. It may be noted that for more intuitive representation of quantitative speed values, rather than absolute values, in the remainder of the disclosure one may denote the speed from robot log as the rate to the full speed ranging between 0.1 to 1.0, proportionally.

Force: At any waypoint, a specified force may be applied through the end effector (hand) as may be shown in FIG. 3. Participants may specify at which waypoint they would like to apply force and show that on the sketch. Then, the participant may specify the magnitude and direction of the force, ranging between 0 to 20 N. Finally, the participant may specify the duration of the force, in seconds. During the practice session, the participants may experience three levels of force demonstration: 5 N, 10 N, and 20 N, to help the participant perceive the scale of the force.

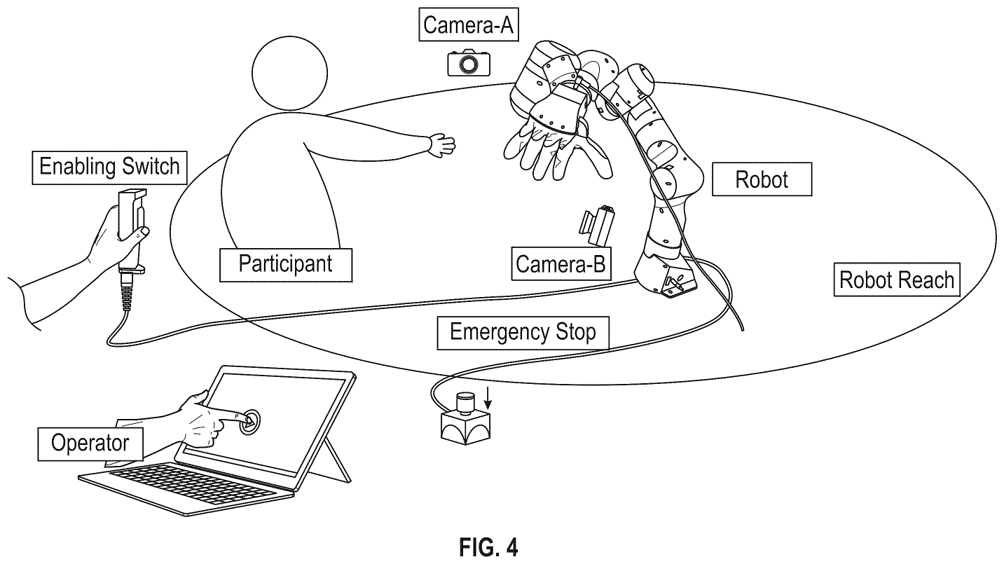

Comfort-related Features: Referring to FIG. 4, to ensure comfort during the interactions, one may implement several hardware and software protection layers. From the hardware point of view, one may utilize Franka arm's locking system, emergency stop device, and the dead-man switch which may allow operating the arm only when the switch is pressed by the operator. From the software point of view, Franka has a software operator that may allow specifying an allowable range for parameters of the robot such as the force and speed, as well as spatial constraints which may restrict the movement of the robot to within only the specified region. The robot may stop immediately when any constraint is about to be violated to protect the participants.

Environmental Configuration: A robotic arm may be mounted on a desk, with two cameras positioned on either side of the arm. For the wiping task, participants may stand in front of the desk, facing the robotic arm. Their arm may be placed on a predetermined sponge block to ensure controlled angles and movements. During the grooming task, participants may sit in a chair to ensure consistent positioning between users. The robotic arm may be flipped to face the back of the room to provide a greater range of movement. A mirror may be positioned on the right side in front of the participants' chair to assist the participants in locating desired points during the design process. A third camera may be placed in front of the chair to capture close-up facial expressions and bodily movements. Adjacent to the robotic arm table, a second desk may serve as a preparation area. A mannequin may be seated in a chair as part of the bodystorming setup. Additionally, a laptop on the desk may provide study instructions and survey questions and may function as the fourth camera to record the bodystorming sessions.

### Participant

In accordance with an embodiment, 20 participants were recruited within the research organization. To balance the population, one may purposefully recruit 10 participants with robotics background (which may be defined if the person is a robotics researcher or engineer working with physical robots in the past 5 years), and 10 participants without robotics background. The participants may include 14 male and 6 female, with ages ranging between 23 and 57 years-old, and coming from a variety of cultural backgrounds and ethnicity including Asian, middle eastern, and white. All participants may be recruited through in-person communication and may not receive direct compensation by participating in the study.

### Procedure

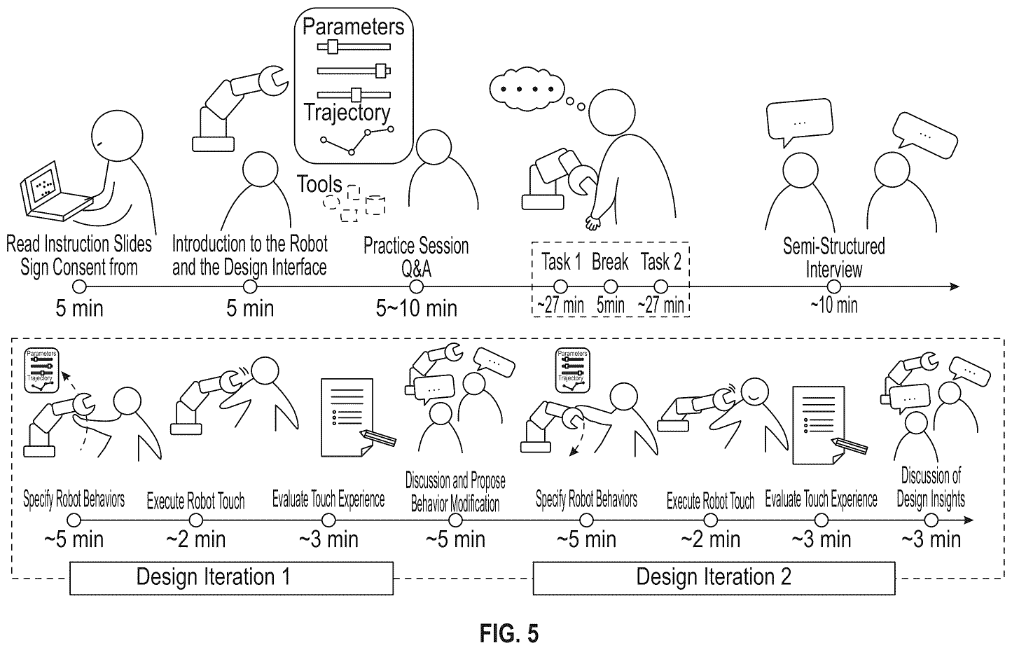

Referring to FIG. 5, upon arrival, participants may be seated at the preparation desk where the participants may be welcomed and given a consent form to read and sign. The researcher may explain the recording procedures and ask participants to complete a demographic form. Participants may review instructional slides and videos about the robot parameters and protocols, addressing any questions the participants may have before proceeding.

The practice task, “press the wound” may begin with a bodystorming exercise. Participants may use their left hand to perform a pressing action on a mannequin, simulating the robotic arm's movements. The participants may proceed to the robotic arm to design the robot's parameters, including trajectory, speed, hand configuration, and material. Throughout the practice co-design session, the participants may receive detailed instructions to guide the participants through the setup and process. The participants may receive a force demonstration where the robot may apply forces of 1 N, 10 N, and 20 N on a toy bear's head providing the participants with first-hand experience of different force levels.

Participants in the experiment may engage in two tasks, wiping the forearm and grooming the hair, using an iterative design methodology. Each task may be comprised of two design sessions, making a total of four design sessions per participant. Similar to the practice round, the design session may start with a bodystorming exercise of the task to familiarize participants with the task. Then, participants may proceed to the robotic arm to design the parameters of the task 1. To counterbalance the order effect, one may randomize the tasks' order for the participants. For the wiping task, participants may stand in front of the robotic arm and place the participant's right arm on a predetermined sponge block. For the grooming task, participants may sit in a chair facing a mirror and maintain a static position during the design session. After the first round of design sessions for task 1, participants may engage in a brief discussion reviewing their experiences and perceptions of the robotic touch. Questions may include the participants' perceptions of comfort, trust, and how the participants may like to improve the participants' design in the second iteration. The participants may move to the second round of design for the same task, followed by a similar touch experience self-evaluation and discussion at the end of session. The goal of the 2nd round of evaluation may be to understand if through the parameter modification the participants may be able to improve the participants' perception or not and in what capacity. Also, participants may be asked to discuss the participants' design insights which may include the positives and negatives and the limitations. After a short break, similar procedures may be repeated for task 2. In accordance with an embodiment, a 5-minute break may be given.

Following the end of the co-design exercise, a post-study interview to debrief participants on their overall experiences during the session may be conducted. The interview may explore participants' perspectives on the future integration of general-purpose physical robots in everyday contexts.

### Measures

One may use both qualitative and quantitative metrics to understand participants' preferences of robot parameters during the participants' design and specification as well as the participants' experience of the touch interaction.

For the quantitative and subjective measures, one may collect participants' self-reported perceived comfort levels after each touch iteration of each task. It may be reported on a 11-Likert scale, with 0 meaning extremely uncomfortable and 10 meaning extremely comfortable. One may collect the perceived between-iteration improvements after the second iteration of each task to evaluate whether the experience may improve in the second iteration compared to the first one. It may be reported on a 11-Likert scale, with 0 meaning ‘much worse’, 5 meaning ‘the same’, and 10 meaning ‘much better’ in the second iteration.

For the objective measures, one may collect the participants' specifications of the robot parameters, specifically, the speeds at each waypoint, the number of waypoints, the force being applied, the material choice of the hand, and the specified hand pose. For the above-mentioned metrics, one may collect four data points for each participant: wipe the arm—Iteration 1, wipe the arm—Iteration 2, groom the hair—Iteration 1, and groom the hair—Iteration 2.

For the qualitative data, one may collect audio and video recordings during the bodystorming, the design and specification phases, the touch execution, and the in-session interviews as well as the post-section interviews for further analysis. Specifically, between the two iterations, participants may be asked to discuss their experience of the first iteration and what parameters the participants may like to change for the second iteration, as well as how the participants may expect the changes may affect the participants' experiences. After the second iteration, participants may be asked to reflect on each parameter choice and the participants' effect on the participants' experience. During the post-experiment interview, participants may be asked to talk broadly about what the participants feel about the experiment and what improvements the participants may imagine for future robots in performing such tasks.

### Quantitative Results

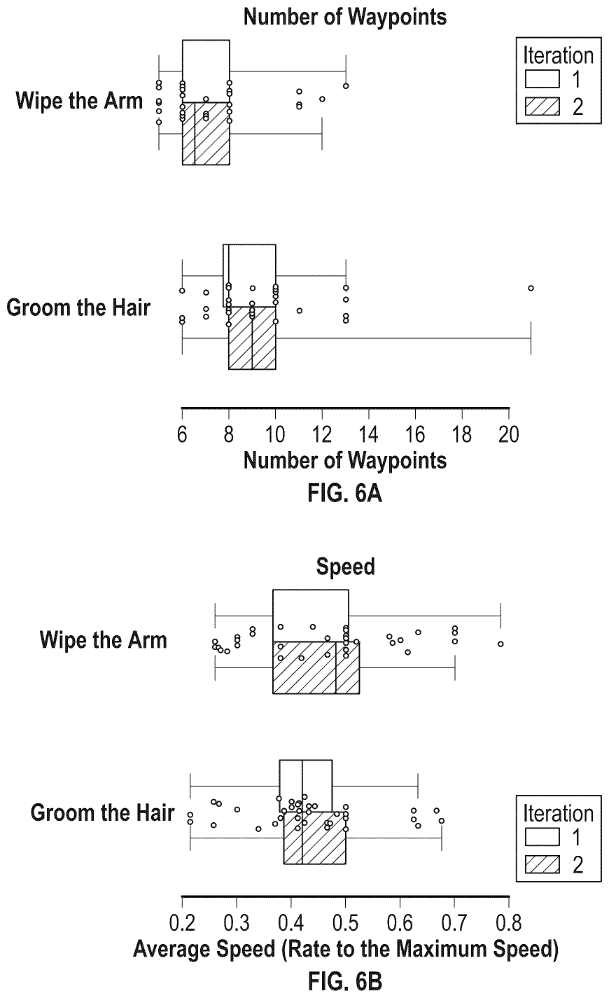

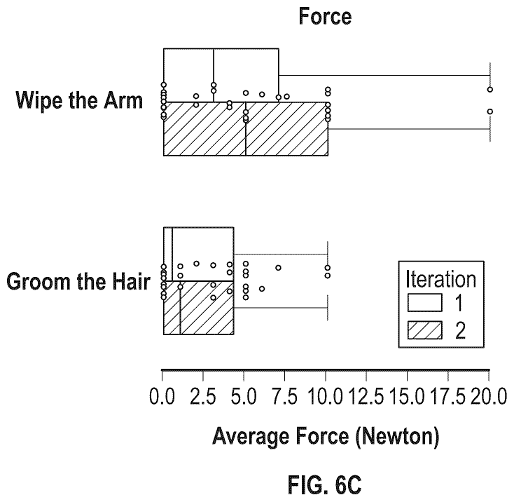

One may perform a quantitative analysis on the robotic parameter specifications provided by participants for the two tasks, the user perception of comfort from the questionnaire, and the changes between the two iterations within each task. FIG. 6A-6C may show the quantitative results for the robot parameters specified by the users.

### Robotic Parameters of Users' Choices

Trajectory Waypoints: Users may specify an average of 7.05+/−2.012 (mean+/−std) waypoints (max=13, min=5, median=6) for the wipe the arm. Specifically, iteration 1 may have 6.95+/−2.04 waypoints (max=13, min=5, median=6.5); iteration 2 may have 7.15+/−2.03 waypoints (max=13, min=6, median=8).

Users may specify an average of 9.225+/−2.675 waypoints (max=21, min=6, median=9) for the groom the hair task. Specifically, iteration 1 may have 8.75+/−1.94 waypoints (max=13, min=6, median=8.0); iteration 2 may have 7.15+/−2.03 waypoints (max=21, min=6, median=9.0).

It may be noticeable that users may specify a higher number of waypoints for the groom the hair task than the wipe the arm task on average. The t-test may reveal the statistical significance of the difference t=4.11, p=0.0001. There may be little difference between the iteration 1 and iteration 2 for the number of waypoints being specified, with the t-test showing no statistical difference either. Specifically, t=0.311, p=0.757 for wipe the arm task between two iterations, and t=1.127, p=0.267 for groom the hair task between the two iterations.

Speed: One may calculate the average speed of the user's specified robotic speed by averaging all the speed value throughout the entire trajectory. Users may specify an average speed of 0.46+/−0.14 for the task wipe the arm (0.46+/−0.14 for iteration 1 and 0.47+/−0.14 for iteration 2). For the groom the hair task, the mean of the average speed is at 0.43+/−0.11 (0.43+/−0.10 for iteration 1 and 0.44+/−0.12 for iteration 2). There may be no statistical difference of the average speed between the two tasks (t=1.152, p=0.253), nor between the two iterations (wipe the arm: t=0.046, p=0.964; groom the hair: t=0.344, p=0.733).

One may analyze the speed at each phase of the trajectory, including speed for the waypoints before physical contact with the user is made, speeds of waypoints that may be in direct contact with the user, and speeds of waypoints after leaving the contact with the user.

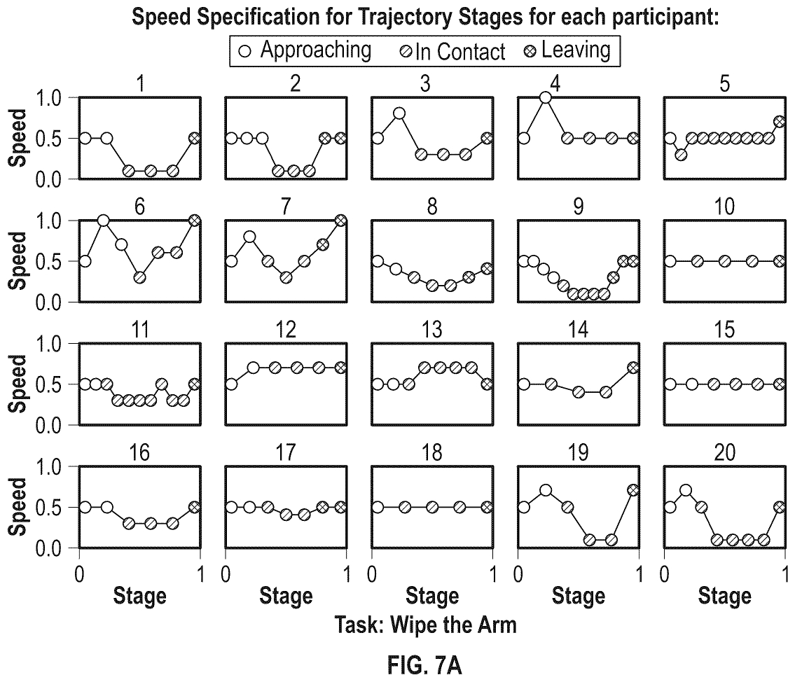

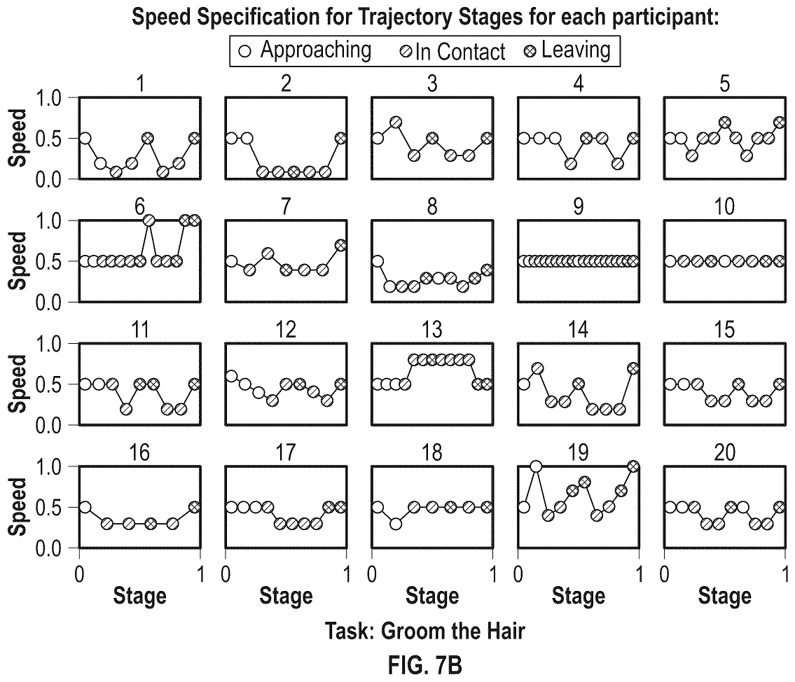

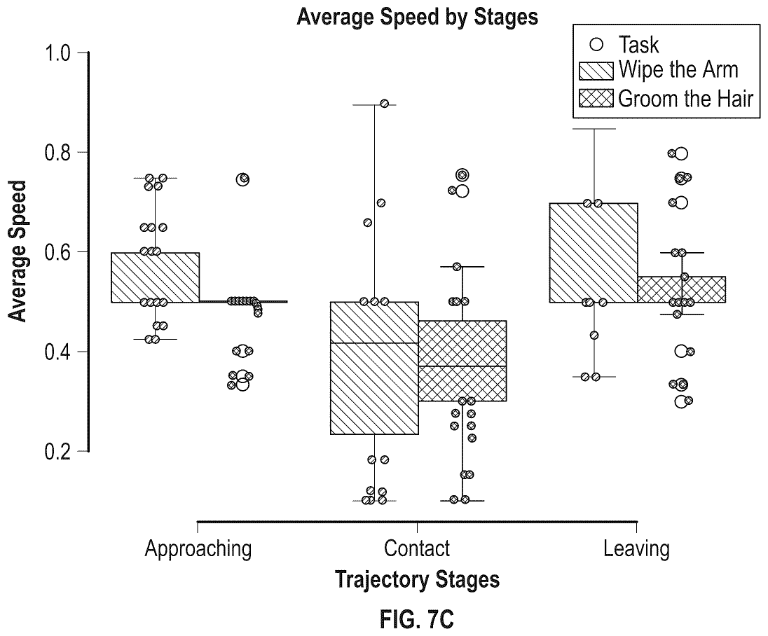

FIGS. 7A-7B may depict the speed specification for the waypoints in a temporal order, for each participant. For each task, one may plot the specification from the second iteration of the task, with x axis indicating the sequence of the specification and y axis indicating the speed being specified in approaching each waypoint during the trajectory sequence. The shading may indicate whether the waypoint is in contact with the body, where a diagonal line shading may mean in direct contact with the body, no shading may mean approaching the body, and an “X” shading may mean leaving the body. It may be noticeable that most of the participants chose a lower speed during contact, and for the phase of robot approaching to make contact, the speed was specified to be low. However, there are participants who decided to keep the same speed (P10) throughout or chose a higher speed during contact (P13), according to the participants' own preferences.

One may compare the average speed between the three stages: approaching, contact, and leaving, as plotted in FIG. 7C. The contact phase may have the lowest average speed at 0.38+/−0.16, followed by the approaching phase 0.52+/−0.08, and the leaving phase may have the highest average speed at 0.54+/−0.13. T-tests may reveal a statistical significance between the speed of contact phase and leaving phase (t=7.04, p<0.0001), as well as the contact phase and the approaching phase (t=6.80, p<0.0001).

Force: One may compare the applied force during the in-contact phases of each task, by averaging the force that has been specified by the participants (value between 0 N and 20 N). For the users who did not select any force to be applied, the force value may be set to 0 N. Users may apply an average of 4.96+/−5.35 N for the task wipe the arm (max=20 N, min=0 N, median=4.0 N), and 2.27+/−2.83 N for the task groom the hair (max=10 N, min=0 N, median=1.0 N). The average force application of the wipe the arm task may be higher than the average force applied for the groom the hair task, with t-test result indicating statistical significance of the difference (t=2.81, p=0.0062).

For the changes between iterations, 9 out of 20 participants may change the force application between two iterations for the wipe the arm task, where 7 participants may increase the force applied and 2 participants decreased the force. 9 out of 20 participants may change the force between two iterations for the groom the hair task, with 5 participants increasing the force, and 4 participants decreasing the force.

Material: Out of the three options provided, the majority (65%) of the participants (per task and iteration) chose the fabric over the other two materials, while 18.75% chose the sponge and 16.25% chose the original robotic hand. Specifically, for the wipe the arm task, 65% chose the fabric, 22.5% chose the sponge, and 12.5% chose the original hand, whereas for the groom the hair task, 65% chose the fabric, 20% chose the original hand, and 15% chose the sponge.

In the discussions, participants may have revealed that the participants preferred the fabric over other materials due to it “smoothness”, “softness”, and “organic textures”. Participants may have described the sponge as “soft” but with “too much friction”, and “too spongy”. For the original hand, participants may have commented “rigid” and “rough”.

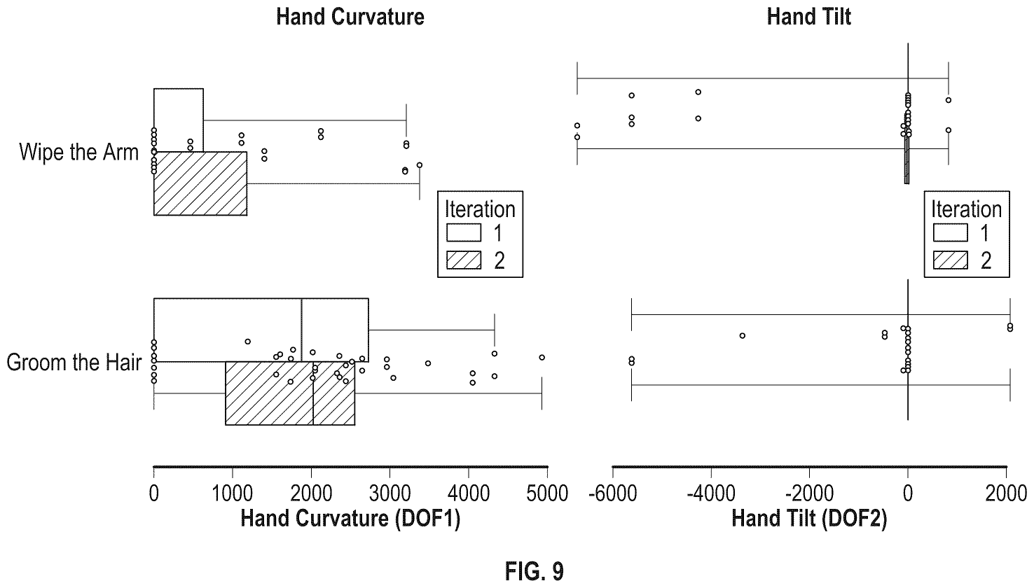

Hand Pose: Referring to FIG. 9, for the wipe the arm task, participants may choose the command values of synergy 1 in a way that may result in a flatter hand compared to the groom the hair task. The average synergy 1 command values of wipe the arm task may be 655.33+/−1138.58 (max=3365, min=0, median=0), and 1820.60+/−1457.20 (max=4932, min=0, median=2005) for the groom the hair task. T-tests may reveal a statistically significant difference for the specification of synergy 1 between the two tasks (t=−3.99, p=0.0002).

For both tasks, most participants may prefer the hand to be close to the neutral pose (synergy 2 command value=0). For wipe the arm task, the average value chosen for the synergy 2 may be—945.00+/−2204.61, with max=806, min=−6750, median=0; while for groom the hair task, the value may be averaged at—293.48+/−1441.90 (max=2079, min=−5654, median=0). No statistical difference may be found between the two tasks in the choice of synergy 2 (t=−1.56, p=0.1218).

### User Perception

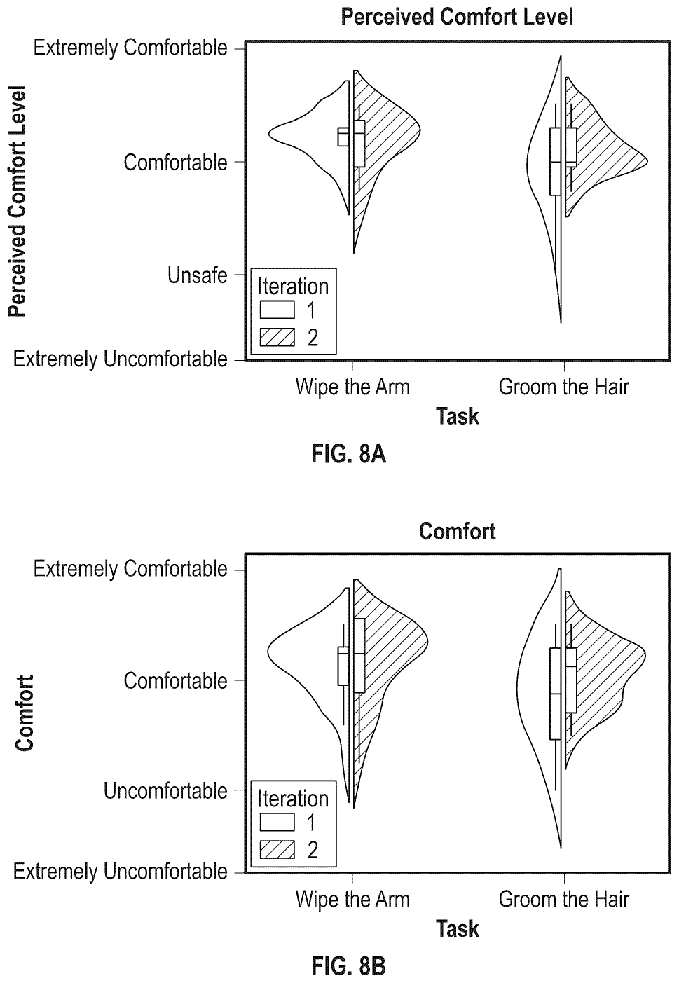

Perceived Comfort Level: Referring to FIGS. 8A-8B, most participants may have indicated that the interactions were comfortable, where they rated an average of 8.45+/−1.22 for the score of perceived comfort level in the 11-Likert scale (0 means extremely uncomfortable and 10 means extremely comfortable). Perceived Comfort Level of the wipe the arm task may be rated higher than the groom the hair task. For wiping the arm, the perceived comfort level may have averaged at 8.82+/−0.96 (max=10, min=6, median=90). For groom the hair, perceived comfort level may have averaged 8.07+/−1.35 (max=10, min=4, median=8). T-tests may have revealed the statistical significance for the differences between the two tasks (t=2.87, p=0.0053).

Comfort: Most participants may have found the touch comfortable, with the self-reported comfort averaged at 8.45+/−1.22. Participants may have rated the groom the hair task less comfortable than wipe the arm task: wipe the arm: mean (std)=8.60+/−1.37, min=5, max=10, median=9; groom the hair: mean (std)=7.85+/−1.59, min=4, max=10, median=8. T-test may show a statistical significance of the difference: t=2.25, p=0.027.

Improvement Between Two Iterations: From the questionnaire, most of the participants (75%) indicated their experiences may have gotten better in the second iteration compared to the first iteration (>6 in the 11-Likert scale, where 5 means the same, 10 means much better, and 0 means much worse) 7.5% participants thought it may have gotten worse (<4), and 17.5% thought it was about the same (4-6).

Participants may have made more improvements of their experience in the groom the hair task. Specifically, for the task wipe the arm, 65% participants may have indicated that second iteration may have been better, 25% felt it may have been the same, and 10% thought it may have gotten worse. For the groom the hair task, 85% the participants thought it may have improved, where only 10% thought it may have been about the same, and 5% thought it may have gotten worse.

When comparing the rated perceived comfort level and comfort, no statistical significance may have been revealed in the difference between the tasks. For the wipe the arm task, participants may have rated the similar perceived comfort level between iteration 1 (8.90+/−0.79) and iteration 2 (8.45+/−0.89), while for groom the hair task, participants may have rated a slightly higher perceived comfort level in the second iteration (8.45+/−0.89) than the first iteration (7.70+/−1.63). Although no statistical significance may have been found in this difference (t=1.81, p=0.078).

Furthermore, one may not notice any statistical differences in the participants' demographics (whether robotic background or not, age, gender, or ethnicity) on the participants' perception of comfort.

### Qualitative Results

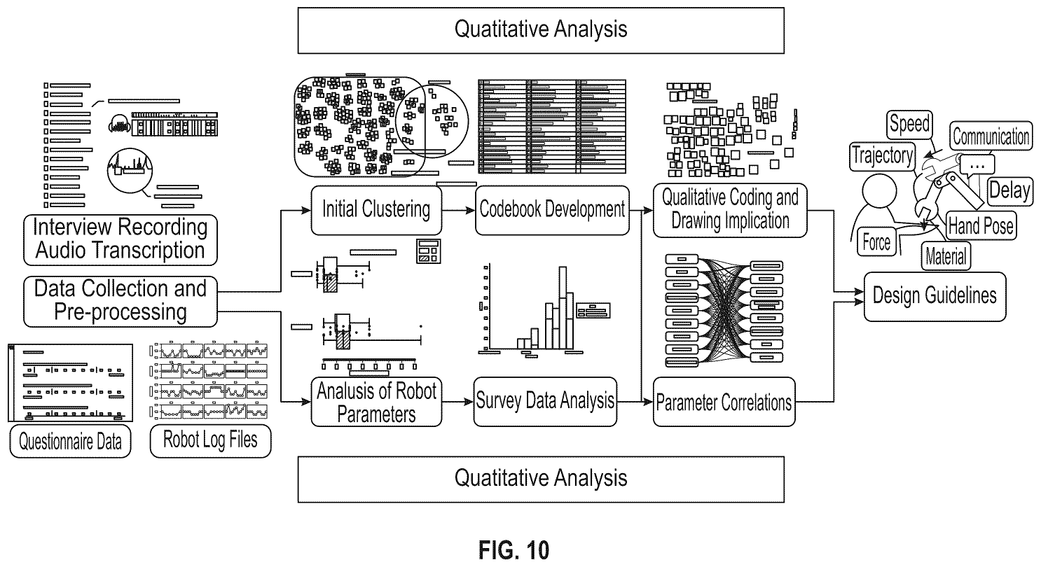

Referring to FIG. 10, below one may present the qualitative analysis and results from participants' interviews conducted during the design iterations, after each task, and at the end of the experiment. One may begin by outlining the procedure for qualitative coding and thematic analysis. This may be followed by a discussion of the robotic and environmental parameters influencing participants' perceptions, including perceived comfort level, comfort, intuitiveness, trust, task performance, and agency. Finally, one may present the correlated robot parameters that may affect human perceptions.

### Qualitative Analysis Procedure

To process and analyze the interview recordings, one may follow a procedure involving audio pre-processing and transcription, codebook development, qualitative coding, and thematic analysis, as may be detailed as below. Two researchers, both with backgrounds in Human-Robot Interaction (HRI) and Human-Computer Interaction (HCI), may conduct the entire qualitative analysis process.

Data pre-processing and transcriptions: One may begin by handling the raw audio files from each session, which may typically contain 1-3 recordings, each lasting between 30 minutes to an hour. Using Audacity, these recordings may be manually segmented into clips corresponding to the study's 13 stages, including the practice tasks and two main tasks with two iterations, each having bodystorming, design, and discussion segments, and the post-interviews. One may enhance the sound quality by reducing noise and equalizing audio levels. This process may produce 254 files. These segmented audio files may be processed in batches to convert to .csv format for further coding, using a script that may employ the Whisper model for automated transcription. To make the analysis process feasible and effective, one may focus on five segmented files for each participant, including between-iteration discussion and post iteration discussion recordings for each task and the post-interview.

Codebook development: To generate the initial codebook one may choose a sample participant (P19) and perform independent coding for the audio transcription files. Then, the two researchers may come together to merge their codes using digital post-it notes. For example, codes like “slow”, “speed design”, “faster” may be all merged to the code “speed”. This collaborative effort may lead to a discussion and clustering of codes, resulting in the initial version of the codebook with 47 codes.

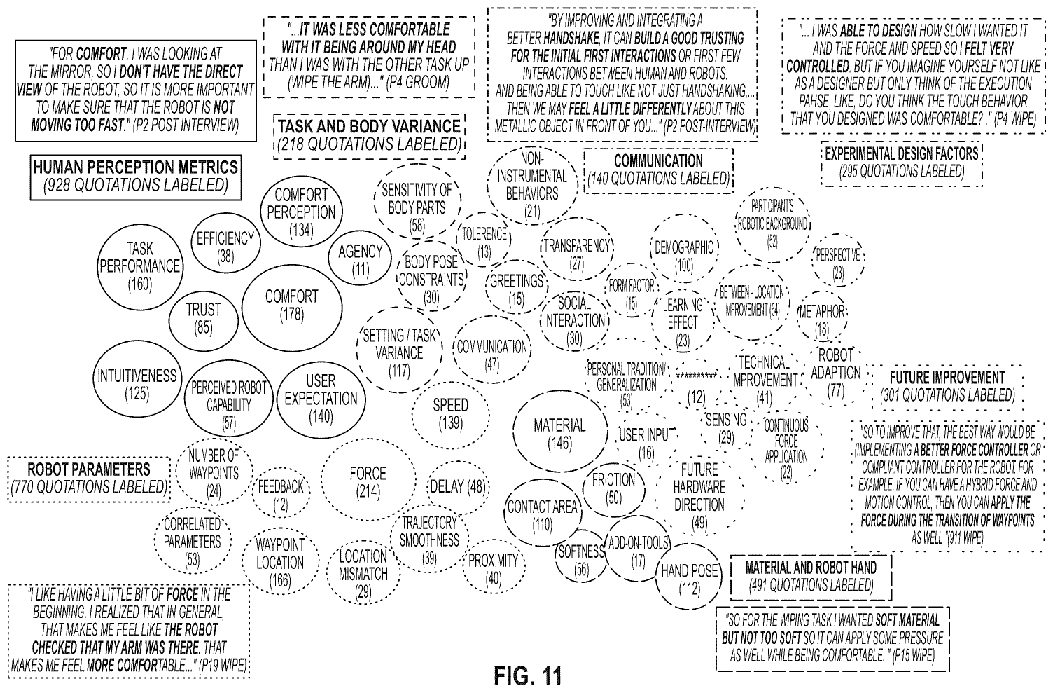

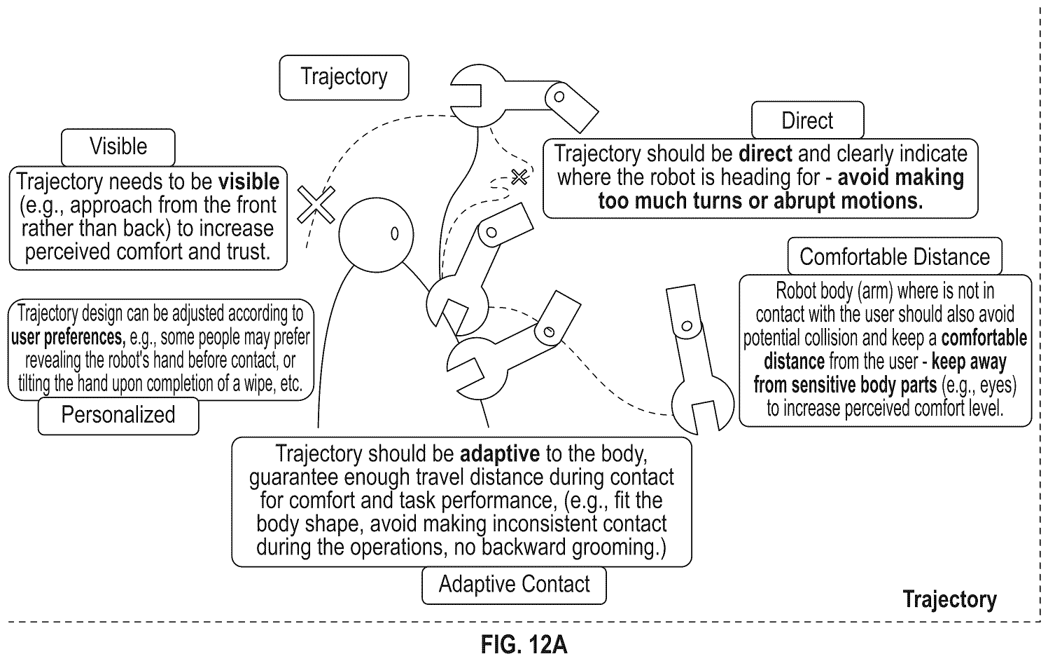

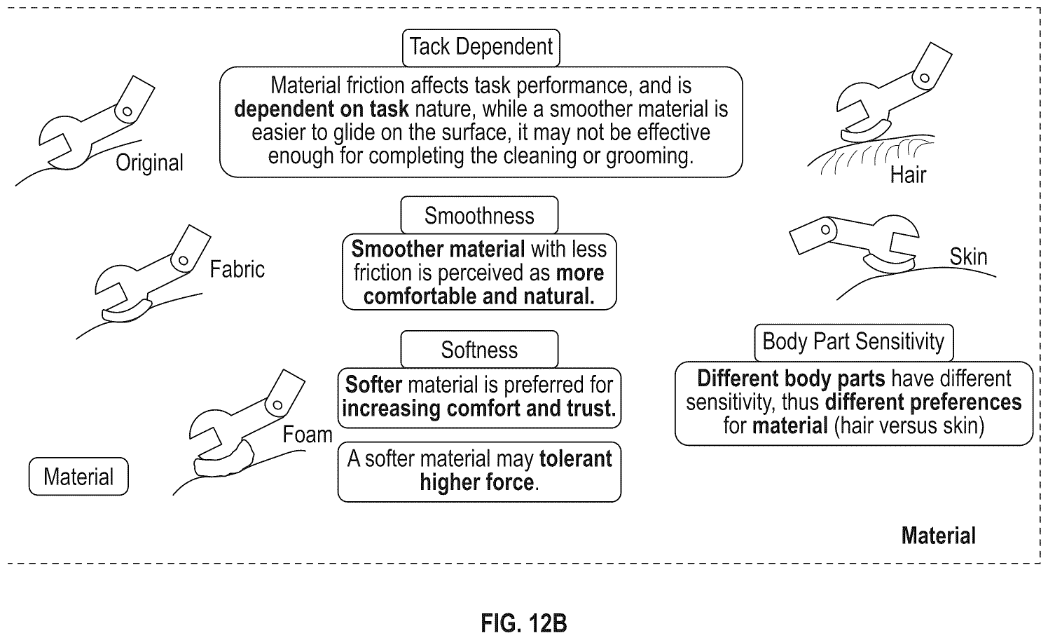

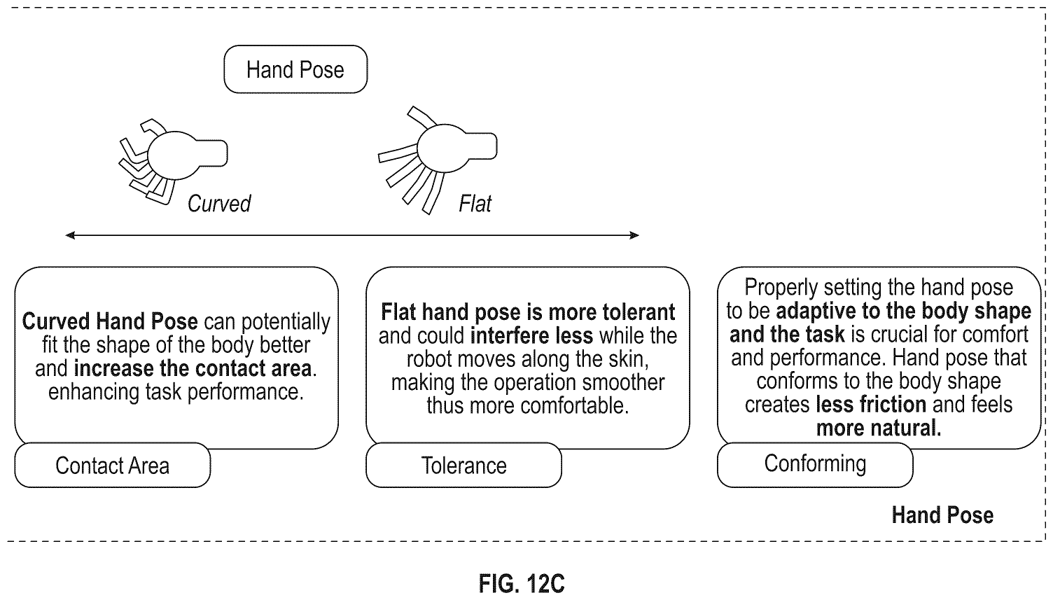

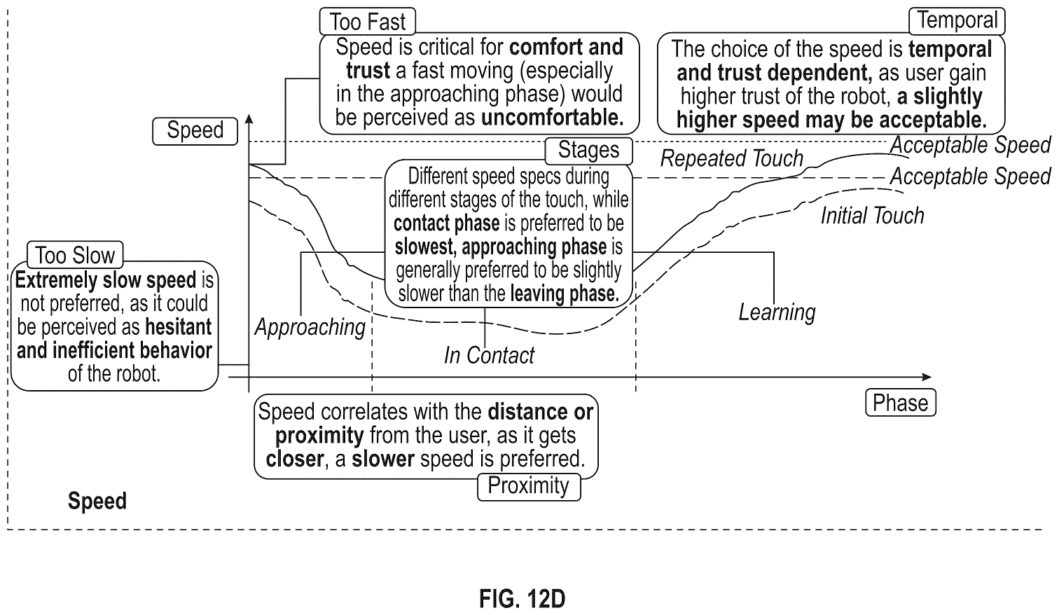

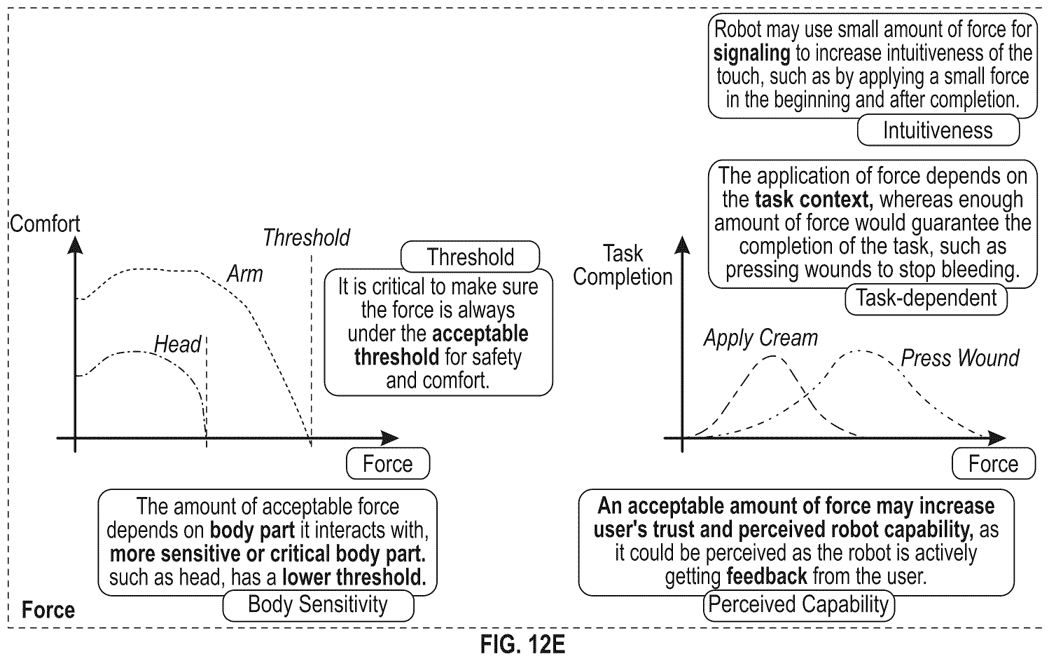

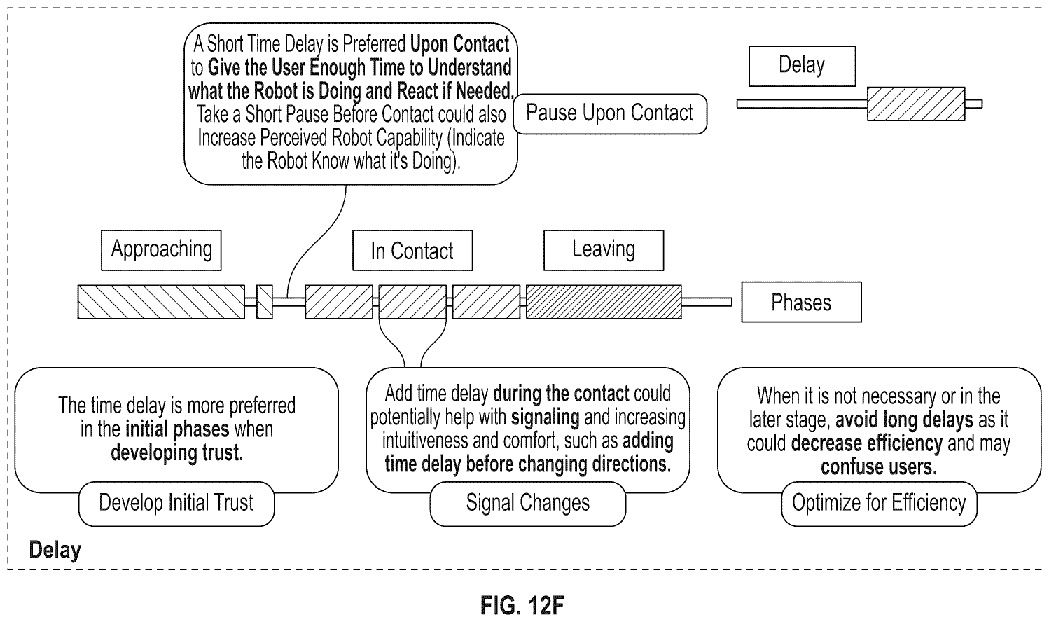

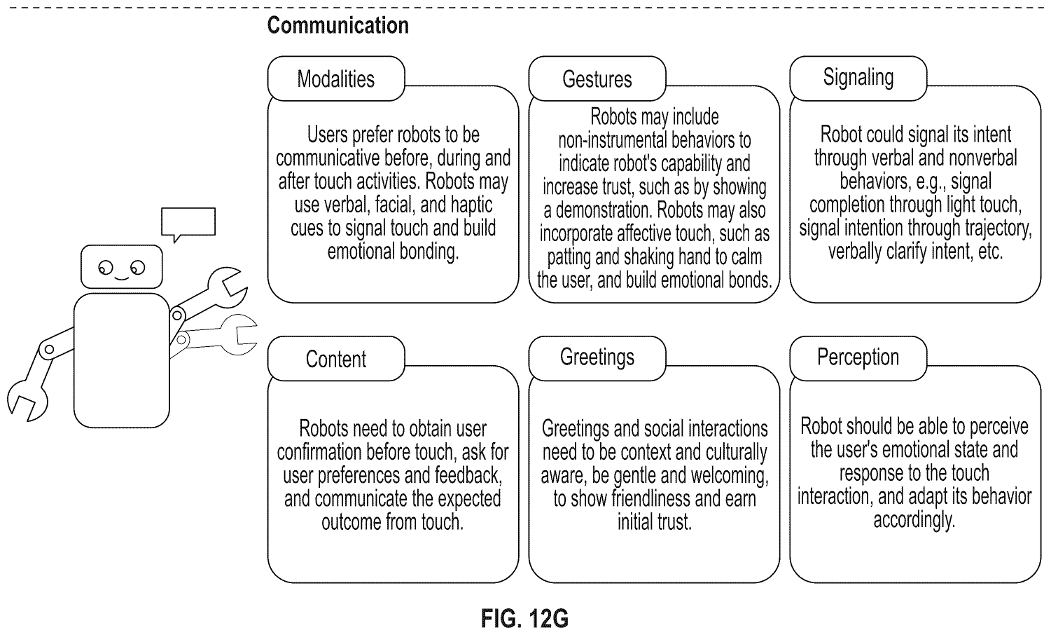

Next, one may perform codebook validation and improvement using another sample participant, P9. During this process, each researcher may individually assign one or more codes to each quotation in the transcription files. They then may check the consistency of the codes and clarify the inclusion and exclusion criteria for each code, discussing any disagreements. Through this process, the researchers may identify eight new codes to be added to the codebook, resulting in a total of 55 codes, as may be shown in FIG. 11. The 55 codes may further be categorized under seven themes: human perception metrics, robot parameters, task and body variance, material and robot hand, future improvement, experimental design factors, and communication.

Qualitative coding: Next, the two researchers may conduct qualitative coding for all the transcription files across the 20 participants. For each quote in the transcription file, a researcher may assign zero, one, or multiple codes. Throughout the coding process, both researchers may independently code all the transcription files, then swap and review each other's codes to reach an agreement. Regular check-ins may be conducted after the 2nd, 5th, 10th, and 20^{th} participants to discuss any issues or unclear quotations. During these reviews, any discrepancies may be discussed, leading to decisions on whether to add or remove codes or to merge specific quotations for further refinement. Ultimately, across all 20 participants, one may identify 1,144 distinct quotations with assigned codes. Finally, all coded data from the files may be aggregated into a meta file. FIG. 11 may present the number of quotations identified under each code.

Thematic analysis: With the final codes established, key findings and insights may be extracted through thematic analysis. This process may involve breaking down the data by themes and individual codes, reviewing and summarizing key insights under each code, and examining cross-theme connections by filtering quotations from two or more codes together to summarize findings. The insights gained from this analysis may be used to interpret users' perceptions of robot touch under different parameter conditions and correlations of the codes, facilitating the creation of results and design guidelines.

In the remainder of this section, one may present the main findings from the thematic analysis, including key factors that may affect participants' perceived comfort level, comfort, intuitiveness, trust, perceived task performance, and agency. One may present the results of several robotic parameter inter-correlations mentioned by participants during their design. Lastly, one may summarize the clustered comments on potential future improvements for robotic hardware and software mentioned by the participants after the interactions. One may not explicitly include the findings on themes related to task and body variance, nor the experimental design factors, as one may focus on the robotic parameters within the scope of this disclose. However, one may briefly summarize and discuss the environmental, contextual, and demographic effects in the discussion section below.

### Comfort Level

There may be 134 quotations mentioning participants' perceived comfort level. Below, one may break these down by robotic parameters and other factors to summarize their individual effects on users' perceived comfort level.

Speed: The Slower, The More Comfortable: A total of 28 quotations may have been identified relating comfort with speed. Participants may have consistently noted that slower speeds may be associated with a higher perception of comfort, especially when the robot was close to their body. “For comfort, I was looking at the mirror, since I don't have the direct view of the robot, so it is more important to make sure that the robot is not moving too fast.” (P02, groom hair).

Force: 16 quotations may have been identified to relate comfort with force. Participants may feel more comfortable when there is just enough amount of force, but too much force may make them feel uncomfortable. For example, P02 noted that: “Maybe I'll put more force. so that I can really feel more, I guess, effort by robot.”, while P10 said: “I don't like having that higher force or more force to the wiping side, that may be different for everyone though”.

Trajectory: Predictable Paths, Greater Comfort: 17 quotations may have been identified to relate comfort level with trajectory waypoints, and 10 additional quotations may relate comfort level with proximity or distance. Participants may have mentioned several aspects of trajectory waypoints regarding the comfort level: (1) Guarantee the rest of the arm not hitting people, as P2 noted, “ . . . robot have more degree of freedom with much wider workspace, so that you can make sure that not only hand, but elbow and shoulders do not hit other stuff.” (2) Visible trajectory could increase comfort, “ . . . it would be good if it could approach somewhere from the front and not just from behind” (P20, groom the hair) (3) Being near sensitive body part decreases comfort level. P20 also wished it “don't start above eye line and don't start within the social distance.”

Contact Body Part: Additionally, 20 quotations may have been highlighted to relate comfort level with contact body part. Different body parts may have different thresholds and comfort perceptions; for instance, the head may be perceived as less comfortable compared to the hand. Regarding the proximity, participants may prefer the robot to (1) start from a more comfortable distance, (2) keep away from sensitive body parts and (3) use conserved parameters when in being near the sensitive areas. As P11 noted, “ . . . it's closer to our head, closer to our eyes. Those are more delicate parts . . . And we have different sensitive regions, like our back is not very sensitive, but hands are very sensitive. So contacting different parts requires different comfort specifications.”

Material: The Softer, The More Comfortable: 9 quotations may have been identified to relate comfort with materials. Participants may have felt that soft materials could cushion any unintended impacts, reducing the risk of injury. “The softness matters in terms of feeling comfortable because it creates like a feeling that this hand cannot just bang it in my arm and like break it . . . this material is there in the middle in case the robot like pushes too hard, the impact is going to be taken by this material.” (P08, wipe)

Additional factors: Several additional factors may be identified that may influence perceived comfort levels. Participants may have highlighted the importance of having control over the interaction. One participant remarked, “I didn't feel uncomfortable at all, because I had emergency button in my own hand, which is good.” (P2, post interview)

Robot form factor changes comfort level perception: “My guess is a smaller robot is probably more comfortable.” (P6, post interview) The effect of the robot's form and participants' general experiences may affect participants' expectations and comfort level perception on the robot. “I saw other robots. These robots crash you. You're not surviving in this thing. So I just have no idea what the forces are about. And I know they can be tremendous. That's why I'm just very careful.” (P6, wipe)

Lastly, comfort level perception may change over time. Participants noted that comfort levels may be more critical for the initial touch, compared to the repeated touch later on. “And when it repeats it, once I feel comfortable, then it could go faster when it left my head after the first touch and then went back to the starting position for the second touch. That part could go faster once the contact was initiated.” (P19, groom)

### Comfort

Participants reported that gentle force, slow and steady movements, precise trajectories, and suitable materials and hand poses may be essential for ensuring comfort.

Force: Gradual Force, More Comfort: The application of force may have been highlighted by 36 quotations as a critical factor for comfort, with lower and gradual forces (less than 10 N) being more comfortable. Participants may have noted that excessive force could be uncomfortable and even harmful. “The action itself wasn't as comfortable because the initial contact had too much force, and it pushed my head forward.” (P10, groom the hair).

Speed: The Slower, Less Stress: 21 quotations may correlate speed with comfort. Slower speeds may have been preferred by participants for enhanced comfort, particularly when the robot was close to the body and during the approaching phase. This slower pace may allow participants to feel more at ease and may reduce the stress of sudden movements. “The robot approached my head too fast. I could see it in the mirror, and that made me uncomfortable.” (P8, groom the hair)

Trajectory: 15 quotations may correlate comfort with the robot's trajectory. Participants may have indicated that it felt more comfortable for the robot to travel for a longer distance, maintain continuous contact, and cover larger area during the touch. “I changed . . . the distance the rubber hand travels while touching my head. I increased that distance. I would say it made the experience more comfortable. So basically, it feels more like a human touching your head based on duration.” (P11, groom the hair) It may be important to ensure that the robot does not make unintended contact with the body. For example, several participants may have noted that back-grooming the hair is uncomfortable.

Contact Body Part: Comfort experiences may have varied with the contacted body parts, with 23 quotes highlighting this relationship. Participants' psychological comfort levels may have differed across body parts, with touching the head generally being less comfortable than touching the arm. Getting close to sensitive spaces (e.g., eyes and face) may further decrease comfort. “I'm socializing with people, people can touch my arm, and it's okay. I'm used to feeling contact from other people on my arm, but not so much on my head. Nobody walks around and touches you on the head. So from that perspective, touching the head was less comfortable.” (P13, post interview)

Material and Hand Pose: During the touch phase, material may have been observed to be related to comfort with 28 quotes. Participants noted that materials with less friction, softer textures, and a more organic feel may provide a more comfortable experience. Participants noted that if there is a mismatch between the material's form and its feel or if the material is unfamiliar to them, it may make them feel uncomfortable. As P8 noted, “ . . . the form is like a human hand, but the material feels a little weird on the skin. So for the first second, I was like, it's not a human hand. So there was this weird conflict because I'm used to either a hard object, like a table or something like that touched my skin or a human touched my skin. And this is too close to a human's hand, but not a human . . . like an uncanny valley . . . I didn't expect that, but I felt it.”

13 quotes may relate hand pose to comfort: A flat hand pose may minimize interference with non-task-relevant body parts, thus may be perceived to offer smoother operation and greater comfort. However, this may not mean that curved poses are less preferred. During the execution phase, a proper curved hand pose may increase relevant body contact, thereby enhancing comfort.

### Intuitiveness

125 quotations may have been found commenting about the intuitiveness of the robot's behaviors. Participants may have suggested that slight force, moderate speed, and clear trajectories may enhance the intuitive feel of the interactions.

Force: 21 quotations may have mentioned force may be used to enhance intuitiveness. A slight application of force at the beginning and end of a task may have been perceived as more intuitive and natural, with the force as an indicator to provide cues and signals of movements. “If the robot hand touches the head before leaving, it should give a little force. This can remind the person that it's sending a signal, that ‘I'm leaving you.’” (P18, groom the hair)

Speed: Speed may be another factor for intuitiveness, with 21 participants noting that a moderate speed may lead to a more natural experience. Slowing down the speed as the robot approached the participant may make the interaction smoother and more human-like. P10 during wiping motion noted: “I feel like if it moves too fast it may alert you because why is this fast robot coming to like grab my arm right away.”. “I think the speed (in the study) wasn't too fast, but also wasn't too slow. I felt the speed is natural and steady.” (P10, groom the hair)

Trajectory: The trajectory of the robot's movements may be important for intuitiveness, as discussed with 24 quotes. A curved path that follows the body's shape and a visible, smooth trajectory may be perceived as more intuitive. “(During the design), trying to clarify the robot's intent was a motivation. Moving in one direction may show people where the robot is heading. One may see abrupt motions as intimidating. One may want the robot to move in a straight line with minimal turns, and any curves should indicate to the user where the robot is going.” (P8, wipe the arm)

Fifteen quotes may relate time delays during the trajectory to intuitiveness, though opinions diverged. Most participants may appreciate the delays, especially short delays upon contact, as they allowed users to understand what the robot was doing and increase the predictability. “When a human being brushes their hair, as long as they are not in a hurry, they wait a little bit longer before the second touch. I would do the same design for the robot by adding a brief pause.” (P11, post interview) However, several participants felt that little or no delay in the trajectory may feel more natural.

Hand Pose: 16 quotes may consider the hand pose affecting the perception of intuitiveness. Hand poses that may conform to the body shape and reduced friction may be perceived as more natural. The hand pose can change which part of the hand—either fingers or palm—makes contact with the human body. This may affect whether the entire interaction feels intuitive, depending on the task. For example, P13 noted that for the “groom the hair” task, it may feel more natural for the fingers to brush the hair instead of using the entire palm, thus curving the hand more. Conversely, for the “wipe the arm” task, it may be more intuitive to keep the hand flat, similar to how humans typically interact.

Participants' Interpretation: Moreover, when interpreting robot motions, participants may refer to their initial expectations and used metaphors to understand their perceived intuitiveness of the touch. For example, for the “groom the hair” task, several participants may have noted that the robot's touch motions better aligned with smoothing their hair or petting their head rather than making any functional grooming or styling, which may require more delicate movements. Participants may have used metaphors and related to their personal experiences to evaluate the tasks. Words such as “scrub,” “pet,” “rub,” “comb,” “comfort,” “grasp,” and “smooth” may have been used to describe the actual task performance of the “groom the hair” task, indicating that different participants may have had varying interpretations of the touch behaviors' effects. Some participants may have mentioned that task performance may be potentially enhanced by adding additional tools, such as a comb, brush, or cleaning wipe, to complete the tasks.

### Trust

85 quotations may have been identified discussing trust toward the robot. Several factors may affect users' trust, including robotic behaviors, users' general attitudes, and prior experiences with the robot. Trust may evolve over time, as it can be increased or broken, leading to varying acceptance of the robot. Below, one may list different factors that may have been identified from the quotations that may affect trust.

Force: 15 quotations may have discussed how force application may affect user trust toward the robot. Users noted that, compared to no force, having an appropriate amount of force may actually increase their trust, as it assured them that the robot knew what it was doing, and knew where the user was. “Pressing firmer on the waypoint probably gave me a better assurance. That it's going to be wiped well. Maybe it didn't, but at least it gave me a feeling that it is more functional.” (P2, wipe the arm)

Speed: Sixteen quotations may connect the robot's speed to trust. Most users may have indicated that “the slower, the more trust,” as an overly fast speed may immediately diminish their trust. As P8 said, “if it's too fast when it approaches it's like a speeding car coming towards you. You don't trust it but if the car or the robot is slow enough that you can understand what it's doing next you can establish trust. That's why I chose four and not five (for speed parameter) because I thought five is too fast when it approached. It's difficult to believe that the robot is going to stop right before it touches you.” However, other users may have noted that if the speed was too slow, it may indicate the robot is hesitant, “like it doesn't know what it's doing,” thus making users feel concerned (P19, wipe the arm).

Trajectory: Participants may have expressed that the predictability of the trajectory may affect their trust. Unexpected behaviors may break their trust, for example if the robot deviates from its expected trajectory, as noted by P11. Moreover, some participants may prefer the robot to make pauses or stops during the trajectory to reassure the user, such as before touching and changing directions. “I feel that stopping a little before getting in contact with the human kind of reassures the human that you know what you're doing and you acknowledge that I know I'm close to the human.” (P8, groom the hair)

Build Trust Through Social Interactions: Robot's social interactions with the user and form factors may affect trust. Some users may have noted that they tend to trust a robot that is more friendly-looking, or express its friendliness prior to the task. “It's very kind looking. Like I can trust this little bubbly guy more than if he was more scary.” (P9, post interview) Users may envision that a robot could build trust through social interactions in greetings, especially for the initial phases. “ . . . by improving and integrating a better handshake, it can build a good trusting for the initial first interactions or first few interactions between human and robots. And being able to touch not just handshaking, but making people being aware that this robot is not like a sensor less object, then we may feel a little differently about this metallic object in front of you.” (P2, post interview) P9 among other participants may have mentioned that robots can build trust by showing a demonstration of its anticipated behaviors to the user prior to the touch interaction.

Trust Changes Over Time: Many participants may have noted that their trust changed over time throughout the experiment. Participants may have suggested that the robot need to incorporate the temporal changes of the trust with the user and choose its behaviors accordingly. P8 noted some factors that are more important to initial stage may be less critical for later and repeated interactions. Participants may have noted that different trust levels may affect the user's acceptance of the robot's touch behaviors, such as allowing for the contact of a sensitive body part after developing trust. “ . . . that will allow you to have established a very good trust in the beginning, which allow to do like touch the skin or even hair, like more close to skin touch.” (P18, post interview)

Environmental and Background Factors: Trust may depend on the general acceptance on a robot and robot touch, and different users may be very different in this aspect, resulting from their personal experiences, cultural background, gender, and age. “I think in a global setting may be some parts of the world may not be exposed to robots interaction and they may not trust as much the technology. (P12, post-interview)” Regardless the familiarity with robotics, users may have different trust on robots. P8, as a robotist, noted that “ . . . even as someone who uses the robots every day, I didn't feel as comfortable as I thought I would when the robot approached my head.”

Participants may have mentioned that due to the experimental setup, being as the designer who generated the robot's behavior made them trust it more, that may not apply in a real-world scenario when someone else designed it. P10 discussed that the trust may depend on the trust on the developer of the robot. “I think it also comes back to who is designing it there . . . I think the manufacturers or the main developers who are making these things their personality or their outlook of the company plays a really big factor in being able to mass market these products . . . so the trust in robot arm interaction does not only rely on the technology itself but also how it's associated in the social level.” (P10, post interview)

### Task Performance

Although not intentionally included in the initial metrics, most participants may have discussed their perception of task performance, with 160 quotations identified. Participants may have mentioned that using task-specific force, moderate slow motions, ensuring proper contact, incorporating higher friction, and maximizing contact may be important for effective and efficient task performance.

Force: As one of the most discussed features in this metric, with 47 quotes, the application of force may have been noted to be critical depending on the nature of the task. For example, gentle force may be insufficient for tasks that require firm pressure, such as wiping to remove dust or pressing a wound to stop bleeding. “To design for the hand wiping task, I want the robot to apply a bit more force. This can allow the robot to do its job effectively; if it's too light, it could miss the actual wound or not wipe it enough.” (P10, wipe the arm)

Speed: Speed may be another factor impacting task performance. 12 quotes may have related the speed to the effectiveness of the task. Movements that were too slow may result in ineffective task completion, such as dragging hair in the “groom the hair” task. Moderately slow motions may be valued as careful handling, which was found to be beneficial for tasks requiring precision, like wiping and rubbing the skin.

16 quotations may have related the speed with efficiency of the task. Participants may have discussed the trade-off between the efficiency and comfort in the choice of speed. “Just as it gets closer and it's actually touching to go a little slower but just for efficiency's sake I was approaching not to go so slow because then it just takes too long.” (P7, groom the hair)

Trajectory: To ensure effective task completion, the robot's trajectory may need to maintain proper contact with the body and eliminate unnecessary interactions, such as the previously mentioned backward-grooming. Across 34 related quotes, participants may have highlighted the importance of tailoring the trajectory to fit their body shapes and needs, such as tilting the arm for better removal of the dust during “wipe the arm” interaction.

Material: Material, especially material's friction, may play a crucial role in interaction with the body surface, as may be noted in 21 quotations. Participants may have discussed the trade-offs of friction affecting task performance in different tasks. For example, P19 preferred a material with higher friction as it made the arm cleaner after wiping, while P13 wanted a smoother material for grooming hair to avoid pulling or dragging, thus smoothing it out gently.

Hand pose: Maximizing contact through the appropriate hand pose may ensure firm task execution. The hand pose may vary significantly based on task requirements, with fingers used more frequently for grooming and the palm for wiping. Since different body parts may have varying levels of sensitivity and complexity, tailoring the hand pose to match the specific body part may became important for the success of task completion.

### Agency

11 quotes may highlight participants' sense of agency during the interaction.

Participants noted that the number of waypoints and the speed may affect how much agency or control they felt in the situation by giving them enough time to understand and respond as the robot performed touch behaviors. For example, P9 chose to have many waypoints in both tasks, which gave them more control over the robot's pace and where it stopped. Besides, the compliance of the robot's movement may affect the level of agency, as said by P6, “[if I don't like the robot's motion,] I would push back”.

Many participants may have noted that the tasks made them feel more passive, as their poses were fixed either on the table or on the chair, requiring enormous trust in the robot. P13 said, “It's a different power dynamics when the person is stuck . . . You kind of have to really trust the robot in order to allow it into your intimate space and allow it to touch you. And there's more to that experience than just the act of grooming.”

Participants may have wished for the robot to demonstrate respectfulness during touch interactions, valuing human autonomy and asking for human input. P7 wished the robot “ . . . asking and making sure their intent is known . . . because people value their autonomy and they want to feel like they have a choice of whether or not they can even [being touched] . . . maybe want some consent . . . ” P13 may have noted that for dependent subjects, it becomes crucial to show empathy and respectfulness when performing the tasks for them.

On the other hand, some participants may have expressed that they valued having tasks executed by robots instead of humans, as they felt less pressure to ask a robot to do things for them. P5 noted this preference, which may be related to the cultural aspect of Japanese politeness and the desire not to inconvenience others. Additionally, P7 mentioned that having some tasks performed by robots respects human agency and privacy, such as performing an invasive procedure by a robot instead of a doctor.

### Correlations Between Robot Parameters

Participants may have commented on the correlated or compensated parameters while they make their design. 53 quotations may have been identified to explicitly talk about the correlations between two or more robotic parameters, elaborated below.

Speed & Force: 4 quotations may have been found correlating speed and force. Participants may have commented that a harder force may compensate for a slower speed. During the design of “wipe the arm” task, P19 noted using additional forces “for compensating the decreasing speed. I think if it's too slow and it's too gentle, it feels kind of off. . . . Either slow and firm, or fast and more gentle. So it feels more natural.”

Material & Force: 9 quotations may have correlated material and force. The selection of materials may affect the perception and acceptance of force. “Because the rubber one has more friction. So apply a little force. And then the fabric one is more smooth and more force.” (P2, wipe the arm)

Material & Trajectory: 3 quotations may have mentioned the trajectory waypoints correlates with material selection, as a softer material may give more tolerance of the waypoints. (P6) On the other hand, the position of the waypoints may need to consider and compensate for the thickness of the materials.

Force & Trajectory: 18 quotations may have been found to talk about the correlations between force and waypoint positions. The position of the waypoint may change the actual force being applied to the user. For example, when P9 wanted to apply more pressure during the “wipe the arm” task, instead of applying pressure by specifying an additional force, they chose to lower the waypoints closer to their skin, “and that's a natural pressure”. Participants also noted that applying force might offset the positions of the existing waypoints, and the design may need to accommodate this adjustment.

Speed & Proximity: 7 quotations may have talked about speed and proximity. The speed choice may be based on the proximity between the user and the robot, generally, users may prefer the robot to slow down when getting close. P8 noted that “ . . . once you are in the area where you're very close to the human you want to start slowing down because we all know humans don't trust robots as much as we'd like them to. So, we want to give them the time to understand that this is what's happening.”

### Robot Limitations and Future Improvements

Participants may identify technical difficulties and suggested potential future improvements and desired robotic features that may currently be missing in the setup. 301 quotations may have been identified reflecting future improvements, including sensing, robot adaptation, hardware directions, and user interfaces.

Adaptation and Personalization: 77 quotations may highlight the need for robot's touch behavior to be adaptable to different tasks, body postures, and body movements. Participants may have discussed the need for adapting the trajectory to the body shape, such as the contour of the head to ensure continuous contact, adapting the robot position with the slight adjustment of the human posture, etc. 33 quotations may have mentioned about the need for personalizing the touch behaviors according to individuals' preferences, including different types of hair styles, skin sensitivities, the physical condition such as the type of injury in the medical touch. Thus, understanding and observing user preferences and adapting the robot's touch behaviors to it may be an important next step to take.

Sensing: Twenty-nine quotations may have discussed potential improvements for the robot's sensing capabilities. Participants may have noted that the current robot control may rely on position and force-based controllers, with no visual feedback integrated into the system. Indeed, visual feedback may be important for identifying a person's pose, estimating touch location, and measuring force. In addition to visual information, participants noted that robots may benefit from additional tactile and force sensors, especially for more dexterous and complex touch interactions, such as massaging.

Hardware Direction: Forty-nine quotations may have addressed additional hardware changes for improvements. Participants may have suggested that the robot could benefit from more anthropomorphic features, such as adding a face, speaker, and mobility, to enhance functionality and create a more friendly appearance. Several participants may have proposed incorporating two arms and enabling bi-manual interactions, which may allow for more complex operations, such as stabilizing or manipulating body parts while performing touch-based tasks. Participants may have discussed potential changes to the hand's material, actuation methods, degrees of freedom, and flexibility, favoring a softer, more conformable, and dexterous hand profile for touch interactions.

### Design Implications

Concluded from qualitative and quantitative findings, one may generate a list of robotic design implications and recommendations of robot's force, speed, trajectory, delay, material, hand pose, and communications.

Trajectory: One may design the robot's trajectory to be visible and easily anticipated, enhancing comfort and trust. The trajectory should adapt to the user's body contours, maintaining comfort and avoiding inconsistent contact. It should be direct and clear, avoiding unnecessary turns or abrupt movements that may cause confusion. Non-contact parts of the robot should stay at a comfortable distance to prevent collisions, especially near sensitive areas like the eyes. Incorporating user preferences into trajectory design, such as hand movements before or after contact, may further improve comfort and satisfaction.

Force: One may recommend that robotic designs ensure force is kept within comfortable limits, adjusted according to the sensitivity of different body parts, and calibrated to suit specific tasks. Additionally, using force to signal the beginning and end of interactions may improve the intuitiveness of the robot's touch interactions.

Speed: One may recommend that the speed should be carefully controlled, particularly during the approach phase, where moderate speeds may be crucial. Speed should be adjusted based on the interaction stage, with the contact phase being the slowest. Proximity to the user also dictates speed, with slower movements preferred as the robot gets closer. However, extremely slow speeds should be avoided to prevent the robot from appearing hesitant or inefficient. Speed adjustments should also consider the user's trust level, allowing for gradual increases as trust develops.

Delay: One may incorporate time delays in robot operations to signal actions, enhancing intuitiveness and comfort. Brief delays upon contact may allow users to anticipate movements and perceive the robot as deliberate and capable. Emphasize delays during the initial interaction phases may build trust, but avoid long delays later on, as they may reduce efficiency and cause confusion. Balancing delays may help maintain both user comfort and the robot's operational effectiveness.

Material: Select soft, smooth, and low-friction materials may be used to enhance comfort and trust during interactions. Softer materials may reduce the risk of discomfort or injury, while smoother textures may offer a pleasant tactile experience. Consider the sensitivity of different body parts, using appropriate materials for each may ensure comfort and effectiveness. Additionally, one may try to match material friction to the task at hand, balancing smoothness for comfort with the necessary friction for tasks like cleaning or grooming.

Hand Pose: One may use a flat hand pose for smoother, more comfortable operations, particularly during long, sweeping motions. For tasks requiring precision and better body contact, a curved hand pose may be ideal, as it fits the body shape and increases the contact area. Adapting the hand pose to the body's contours and task requirements may be needed for both comfort and performance, ensuring a natural, intuitive feel during interactions.

Communication: Robots should proactively communicate their intentions before, during, and after touch interactions to build trust and ensure users understand their actions. Seeking user confirmation and preferences before initiating touch may allow for personalized, comfortable interactions. Throughout the process, robots may gather feedback and adapt their behaviors based on users' emotional and physical states. Incorporating greeting behaviors, such as handshakes or pats, may help establish initial trust, while maintaining social and cultural awareness may ensure that touch interactions are appropriate, gentle, and welcoming.

How do users perceive robotic touch, and what behaviors should the robot integrate for comfortable and intuitive touch? The above may aim to answer this question through users' reflections after they design and experience the robot's touch behaviors physically. One may approach this problem with a broad perspective, with few hypotheses or pre-assumptions. Instead, the present method may be exploratory, aiming to reveal potential correlations through clustered participant comments.

Through two real-world tasks, “wipe the arm” and “groom the hair”, participants may be able to generate robot behaviors that were feasible and perceived as comfortable. With two iterations of design, most participants may be able to improve their experience after making changes to the robot behavior for the second iteration.

It may be noticeable that different participants have similarities and differences in their choice of robotic parameters. For example, while most participants may choose to lower the speed during contact, one participant increased the contact speed as it felt “more natural” to them. Additionally, although most participants may prefer smooth fabric material, several participants noted a preference for other materials due to tactile feelings, body sensitivity, and even hair type. Thus, although robots may choose default parameters to cater to general preferences, it may be important to understand and adapt to individual preferences accordingly.

Considering the generalization of behaviors to different body parts and task scenarios, the above results may suggest that users may have different sensitivities and comfort levels when touched on different body parts, such as the head versus the arm. This results in varying acceptable ranges of force, number of waypoints, and hand poses. It may be necessary for the robot to consider the contact location and adapt its behaviors accordingly. In this experiment, one may select tasks that may involve gliding on the skin or hair surface. Different tasks may require varying parameters for force and trajectory complexity. For example, in the practice task “press the wound,” participants may apply higher force but use fewer waypoints compared to the two main tasks. Further experiments may be needed to better understand the generalizability and uniqueness of different types of tasks and parameters.

Through thematic and cross-theme analysis of interviews, the above results may provide a deeper understanding of how robotic parameters influence participants' perceptions of trust, comfort, intuitiveness, and task performance. Based on these findings, one may offer a list of design recommendations. Beyond the parameters defined in the experiment (force, speed, trajectory, delay, material, hand pose), participants may identify additional factors affecting their perceptions. Environmental factors, such as the physical setup of the space—like having a mirror to allow participants to see the robot working on their back—and the experimental design, including providing an emergency button, may impact their sense of agency and perceived comfort. Moreover, the robot's embodiment and communication factors may play a role in shaping participants' perceptions of friendliness and potential harm, thus influencing trust. For instance, a robot with a smile may be perceived as more friendly and acceptable to touch.

Participants' perception and acceptance of robotic touch may evolve over time, potentially developing greater trust in the robot. This co-design experiment, which may include multiple tasks and iterations, may reveal a learning effect. Participants may become more accustomed to the robotic touch, resulting in increased tolerance of parameters as the experiment progressed. However, as the experiment lasted 90 minutes, some participants may have become bored, leading to less exploration in later specifications compared to earlier ones. Many participants noted in interviews that it may be crucial for the initial touch interaction to be comfortable and trustworthy. Over time, once they felt comfortable with the robot, they may prioritize task performance and efficiency, such as choosing a slightly higher speed. It may be important for robots to account for this temporal or learning effect and adapt their behaviors as participants gain familiarity with the robot.

Participants may relate their experience with robotic touch to their personal life experiences. Their demographic background and general acceptance of being touched by robots may set default expectations and influence their perceptions, especially during initial interactions. For instance, cultural backgrounds may play a role in feeling less comfortable with touch, or less exposure to robotic technologies in the society might lead to less accepting of it. Additionally, personality traits may affect participants' perceptions and their choice of parameters. For example, a more risk-averse participant might choose a more conservative speed and force, particularly before they have developed trust in the robot.

One limitation of this experimental design may be the potential bias arising from participants acting both as evaluators and designers. As many participants noted, because the participants created the behaviors, these were more predictable and tended to be more trusted. While this approach may be a good first step in understanding how users generally design and perceive robot behaviors, further follow-up studies may be necessary to understand perceptions from a purely evaluator perspective. Specifically, one may need to examine how users with no prior knowledge of the robot perceive it.

As disclosed above, an exploratory co-design user experiment may be disclosed to understand robotic behaviors for robot-initiated touch interactions. One may conduct the experiment with 20 participants to specify, evaluate, and iterate robot behaviors for two instrumental touch tasks. Through qualitative and quantitative analysis, one may find that the robot's force, speed, material, hand pose, and trajectory may affect user's perceptions of comfort, trust, task performance, intuitiveness, etc. Moreover, robots' parameters may be inter-correlated, and the preference may vary based on the task context, and the body part it interacts with. One may provide a set of design guidelines for robotic behaviors and parameters to set a foundation and provide inspirations for future researchers and practitioners in physical human-robot interactions.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for determining robotic touch parameters through participatory experiments of physical human-robot interactions comprising:
selecting different robotic parameters for performing different robotic touch tasks by a participant;
experiencing each robotic touch task with the different robotic parameters selected by the participant;
evaluating each robotic touch task with the different robotic parameters selected by the participant; and
updating the different robotic parameters for performing the different robotic touch tasks by the participant.

2. The method of claim 1, comprising experiencing each robotic touch by the participant with the different robotic parameters updated.

3. The method of claim 2, comprising evaluating the experience of each robotic touch task by the participant with the different robotic parameters updated.

4. The method of claim 1, comprising performing a practice task with the participant allowing the participant to experience at least one of the different robotic parameters.

5. The method of claim 1, comprising performing a bodystorming activity allowing the participant to perform a human touch action on a mannequin.

6. The method of claim 5, wherein the human touch action is one of the physical human-robot interactions.

7. The method of claim 1, comprising performing a robotic force demonstration showing a plurality of different applied robot force levels to an object.

8. The method of claim 1, wherein evaluating the experience of each robotic touch task uses qualitative and quantitative metrics.

9. The method of claim 1, wherein evaluating the experience of each robotic touch task comprises collecting a report from the participant on perceived comfort level of each robotic touch task.

10. The method of claim 1, wherein evaluating the experience of each robotic touch task comprises collecting a report from the participant on perceived comfort level of each robotic touch task using a Likert scale.

11. The method of claim 1, wherein evaluating the experience of each robotic touch task comprises collecting and analyzing audio and video recordings of the participant during the performance of the method.

12. The method of claim 1, wherein evaluating the experience of each robotic touch task comprises:
collecting a report from the participant on perceived comfort level of each robotic touch task; and
collecting and analyzing audio and video recordings of the participant during the performance of the method.

13. The method of claim 1, with the different robotic parameters comprises: number of waypoints, speeds at each waypoint, force applied, material choice for a robotic hand, and specified hand pose.

14. The method of claim 1, wherein the different robotic touch tasks are at least two different robotic touch tasks, wherein each of the at least two different robotic touch tasks touch different body parts.

15. A method for determining robotic touch parameters through participatory experiments of physical human-robot interactions comprising:
performing a bodystorming activity allowing each participant of a plurality of participants to perform a human touch action on a mannequin;
determining individually different robotic parameters for performing different robotic touch tasks by each participant;
experiencing by each participant each robotic touch task with the different robotic parameters corresponding with each participant;
evaluating by each participant the experience of each robotic touch task with the different robotic parameters corresponding with each participant;
updating by each participant the different robotic parameters for performing the different robotic touch tasks;
experiencing by each participant each robotic touch task with the updated different robotic parameters corresponding with each participant; and
evaluating by each participant the experience of each robotic touch task with the updated different robotic parameters corresponding with each participant.

16. The method of claim 15, comprising performing a practice task with each participant allowing each participant to experience at least one of the different robotic parameters.

17. The method of claim 15, comprising performing a robotic force demonstration showing a plurality of different applied robot force levels to an object.

18. The method of claim 15, wherein evaluating by the selecting participant the experience of each robotic touch task with the different robotic parameters selected by the selecting participant and evaluating the experience of each robotic touch task with the updated different robotic parameters by the selecting participant comprises:
collecting reports from each participant on perceived comfort level of each robotic touch task; and
collecting and analyzing audio and video recordings of each participant during the performance of the method.

19. A method for determining robotic touch parameters through participatory experiments of physical human-robot interactions comprising:
performing a robotic force demonstration showing a plurality of different applied robot force levels to an object;
performing a practice task with each participant allowing each participant to experience at least one of the different robotic parameters;
performing a bodystorming activity allowing each participant to perform a human touch action on a mannequin;
allowing each participant to individually select different robotic parameters for performing different robotic touch tasks;
allowing each participant to experience each robotic touch task with the selected different robotic parameters corresponding with each participant;
evaluating the experience of each robotic touch task with the selected different robotic parameters corresponding with each participant;
adjusting the different robotic parameters for performing the different robotic touch tasks by each of the participants;
allowing each participant to experience each robotic touch task with the adjusted different robotic parameters corresponding with each participant; and
evaluating the experience of each robotic touch task with the adjusted different robotic parameters corresponding with each participant.

20. The method of claim 19, wherein evaluating the experience of each robotic touch task with the selected different robotic parameters corresponding with each participant and evaluating the experience of each robotic touch task with the adjusted different robotic parameters corresponding with each participant comprises:
collecting each participant report on perceived comfort level of each robotic touch task; and
collecting and analyzing audio and video recordings of each participant during the performance of the method.
